(19) United States
(12) Patent Application Publication
(10) Pub. No.: US 2009/0073566 A1
(43) Pub. Date: Mar. 19, 2009

(54) OPTICAL SHEET FOR DISPLAY UNIT AND MANUFACTURING METHOD THEREOF

(75) Inventors: Ryuichi Katsumoto, Shizuoka (JP); Hideo Nagano, Shizuoka (JP); Keisuke Endo, Shizuoka (JP); Yoshisada Nakamura, Shizuoka (JP); Akihiko Takeda, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/065,176

(22) PCT Filed: Aug. 29, 2006
(86) PCT No.: PCT/JP2006/317409

§ 371 Date: Jul. 13, 2008

(30) Foreign Application Priority Data
Aug. 31, 2005 (JP) 2005-252054
Sep. 12, 2005 (JP) 2005-263852
Sep. 12, 2005 (JP) 2005-263853

(51) Int. Cl. G02B 27/12; G02B 5/00; B32B 37/06

(52) U.S. Cl. 359/599; 359/619; 359/622; 156/250; 156/272.8

(57) ABSTRACT

In a manufacturing method of the present invention, a diffusion sheet having a flat size of a product size or more is laminated to a front surface and/or back surface of a lens sheet having flat size of the product size or more, and the stack is cut along its periphery into the product size, and the lens sheet and the diffusion sheet are bonded to each other at least one or more peripheral points thereof. This eliminates a step for individually cutting a number of films (sheets) into a product size, and a step for aligning the number of films (sheets) for lamination. In addition, the method does not cause a problem of waste of protective sheets, but provides advantages in both cost and quality. There is no problem caused in laminating a number of films, or problems caused by different thermal expansions/thermal shrinkages of a plurality of films.

### TECHNICAL FIELD

The present invention relates to an optical sheet for display unit and a manufacturing method thereof, in particular, an optical sheet for display unit which is preferable to manufacture a stack of sheet materials to be used in a liquid crystal display and the like in simpler steps and at lower cost compared to conventional methods, and a manufacturing method thereof.

### BACKGROUND ART

In recent years, electronic displays such as liquid crystal displays and organic ELs are provided with films which diffuse light from a light source such as a planar optical platform, or lens films which condense the light toward the front of the displays.

The films often include various optical films (sheets) laminated therein. For example, Japanese Patent Application Laid-Open No. 2004-184575 (Patent Document 1) provides a transflective polarizing film in which a reflective polarizing film, a retardation film, and a transflective layers are laminated in no particular order, and an adsorptive polarizing film is further laminated to the three layers. According to the above patent document 1, five of the transflective polarizing films are interposed between a light source apparatus and liquid crystal cells, and this configuration enhances screen brightness and reduces power consumption.

Japanese Patent Application Laid-Open No. 7-230001, Japanese Patent Registration No. 3123006, and Japanese Patent Application Laid-Open No. 5-341132 (Patent Documents 2 to 4) individually disclose a film which has both functions of light diffusing film and lens film.

### DISCLOSURE OF THE INVENTION

However, in the conventional configurations of films in the above patent documents, lamination of a number of films requires a lot of steps, and the complicated steps eventually result in an increase of manufacturing cost.

Planar lenses such as lenticular lens or prism sheet have fragile and easily contaminated surfaces, and so in delivery, for protection, such planar lenses are usually covered with protective sheets.

However, these protective sheets will be removed from the lenses in use and be discarded. This is not preferable from the view point of a waste of resource as well as an increase of manufacturing cost. Also, this configuration requires a step for removing a protective sheet from a planar lens, which leads to lower productivity. In addition, removing a protective sheet from a planar lens generates electrical charges which tend to attach contamination such as dust and dirt to the planar lens, and this is another problem from the view point of quality.

In laminating a number of films (sheets), frictions in the lamination, stresses due to different thermal expansions/thermal shrinkages, scratches in handling and the like often cause damages in the film surfaces.

If a failure (deformation, curl, or the like) due to different thermal expansions/thermal shrinkages between films occurs, in order to correct the failure, several actions such as increasing a thickness of individual film (e.g. for increasing of rigidity) are often needed. Thus, a lamination of a number of films has disadvantages of restrictions on design, increased manufacturing cost, and the like.

The present invention was made in view of the above background, and one object of the present invention is to provide an optical sheet for display unit which is preferable to manufacture a stack of sheet materials to be used in display units such as a liquid crystal display in simpler steps at lower cost and with higher quality compared to conventional methods, and a manufacturing method thereof.

In order to achieve the above object, the present invention provides an optical sheet for display unit, comprising: at least one lens sheet having convex lenses which are oriented in one axial direction and arranged adjacent to each other generally over an entire surface of the lens sheet; a diffusion sheet laminated to a front surface and/or back surface of the lens sheet, wherein the lens sheet and the diffusion sheet are bonded to each other at least one or more peripheral points thereof.

In order to manufacture the above optical sheet, the present invention provides a manufacturing method of optical sheet for display unit, comprising: a laminating step for laminating a diffusion sheet having a flat size of a product size or more to a front surface and/or back surface of at least one lens sheet having a flat size of the product size or more and having convex lenses which are oriented in one axial direction and arranged adjacent to each other generally over an entire surface of the lens sheet; a cutting step for cutting the stack of the diffusion sheet and the lens sheet along its periphery into the product size; and a bonding step for bonding the lens sheet and the diffusion sheet to each other at least one or more peripheral points thereof.

According to the present invention, a diffusion sheet having a flat size of a product size or more is laminated to a front surface and/or back surface of a lens sheet having a flat size of the product size or more, and the stack is cut along its periphery into the product size, and then the lens sheet and the diffusion sheet are bonded to each other at least one or more peripheral points thereof.

Thus, a step for individually cutting a number of films (sheets) into a product size, and a step for aligning the number of films (sheets) for lamination are eliminated. The method of the present invention provides no problem with respect to a protective sheet, and provides an advantage of reduced cost and improved quality. Moreover, there is not any problem such as those described above in laminating a number of films, or those due to different thermal expansions/thermal shrinkages of a plurality of films.

In terms of the above advantages, according to the present invention, an optical sheet for display unit can be manufactured in simpler steps at a lower cost and with higher quality compared to conventional methods.

As used herein, the term “lens sheet having convex lenses which are oriented in one axial direction and arranged adjacent to each other generally over an entire surface of the lens sheet” includes lenticular lenses and prism sheets as well as diffraction gratings and the like.

As used herein, the term “sheet having a flat size of a product size or more” means that not only a flat size of a lens sheet or diffusion sheet is larger than a product size but also a flat size of a lens sheet or diffusion sheet may be the same with a product size. In the latter case, the lens sheet or diffusion sheet may not be cut along its one or more edges in the cutting step.

In order to achieve the above object, the present invention provides an optical sheet for display unit, comprising: two lens sheets having convex lenses which are oriented in one axial direction and arranged adjacent to each other generally over an entire surface of each lens sheet, the two lens sheets being laminated to each other in a direction with which the axis of the convex lenses intersects at a generally right angle; and a diffusion sheet laminated to a front surface and/or back surface of the stack of the lens sheets, wherein the lens sheets, and the lens sheet and the diffusion sheet are bonded to each other at least one or more peripheral points thereof.

In order to manufacture the above optical sheet, the present invention provides a manufacturing method of optical sheet for display unit, comprising: a laminating step for laminating two lens sheets, having a flat size of a product size or more and having convex lenses which are oriented in one axial direction and arranged adjacent to each other generally over an entire surface of each lens sheet, to each other so that the axial directions of the convex lenses on each sheet intersect with each other at a generally right angle, and laminating a diffusion sheet having a flat size of the product size or more to a front surface and/or back surface of the stack of the lens sheets; a cutting step for cutting the stack of the diffusion sheet and the lens sheets along its periphery into the product size; and a bonding step for bonding the lens sheets, and the lens sheets and the diffusion sheet to each other at least one or more peripheral points thereof.

According to the present invention, the configuration with two lens sheets being laminated so that the axial directions of the convex lenses on each sheet intersect with each other at a generally right angle and a diffusion sheet being laminated to a front surface and/or back surface of the stack also provides the various effects as described above. Therefore, according to the present invention, an optical sheet for display unit can be manufactured in simpler steps at a lower cost and with higher quality compared to conventional methods.

Although the lens sheets are described to be laminated arranged so that the axial directions of the convex lenses on each sheet intersect with each other at a generally right angle, the angle may be slightly adjusted to prevent Moire fringes.

In the present invention, in the bonding step, the lens sheets and/or the diffusion sheet are preferably fusion-bonded to each other. The lens sheets and/or diffusion sheet may be adhesively bonded, but fusion-bonding is preferable because it simplifies the bonding step. The lens sheets and/or diffusion sheet may be fusion-bonded by heating with ultrasonic waves, heating with laser beam irradiation, or the like.

In the present invention, in the bonding step, the lens sheets and/or the diffusion sheet are preferably adhesively bonded to each other. The lens sheets and/or diffusion sheet may be adhesively bonded by an adhesive as well as a double-faced adhesive tape.

In the present invention, the cutting step and the bonding step are preferably performed generally simultaneously by irradiating a laser beam. The cutting may be performed by machining (for example, shirring or stamping), but a laser beam (especially, carbon dioxide gas laser) is suitable for cutting of a resin sheet, and also is advantageous from the point of layout. In addition, the use of a laser beam allows the cutting step and the bonding step to be performed simultaneously, which preferably simplifies the steps.

In the present invention, in the bonding step, the lens sheet and the diffusion sheet are preferably bonded along at least one peripheral edge portion thereof. In the present invention, in the bonding step, the lens sheets, and the lens sheets and the diffusion sheet are preferably bonded along at least one peripheral edge portion thereof. Such bonding along at least one peripheral edge portion of the stack makes the stack more strongly fixed.

In the present invention, in the bonding step, the lens sheet and the diffusion sheet are preferably bonded to each other along four peripheral edge portions thereof. In the present invention, in the bonding step, the lens sheets, and the lens sheets and the diffusion sheet are preferably bonded to each other along four peripheral edge portions thereof. Such bonding along four peripheral edge portions makes the stack more strongly fixed, and more effectively prevents contaminants such as dust from entering between the sheets.

In the present invention, the lens sheet and the diffusion sheet preferably have a generally similar thermal expansion coefficient. This prevents the above problems due to different thermal expansions/thermal shrinkages of films.

Specifically, a difference Δα between a thermal expansion coefficient of a lens sheet and that of a diffusion sheet is preferably 2% or less, more preferably 1% or less, most preferably 0.05% or less.

In order to achieve the above object, the present invention provides an optical sheet for display unit in which two or more optical sheets are laminated, the optical sheets being bonded to each other at least one or more peripheral points thereof.

In order to manufacture the above optical sheet, the present invention provides a manufacturing method of optical sheet for display unit, comprising: a laminating step for laminating two or more optical sheets having a flat size of a product size or more to each other; a cutting step for cutting the stack of the optical sheets along its periphery into the product size; and a bonding step for bonding the stack of the optical sheets to each other at least one or more peripheral points thereof.

According the present invention, two or more optical sheets having a flat size of a product size or more are laminated, and the stack is cut along its periphery into the product size, and bonded to each other at least one or more peripheral points thereof.

Thus, a step for individually cutting a number of films (sheets) into a product size, and a step for aligning the number of films (sheets) for lamination are eliminated. The method of the present invention provides no problem with respect to a protective sheet, and provides an advantage of reduced cost and improved quality. Moreover, there is not any problem such as those described above in laminating a number of films, or those due to different thermal expansions/thermal shrinkages of a plurality of films.

In terms of the above advantages, according to the present invention, an optical sheet for display unit can be manufactured in simpler steps at a lower cost and with higher quality compared to conventional methods.

As used herein, the term “optical sheet (optical film)” may be any sheet having an optical function, including diffusion sheets, sheet polarizers (polarizing films), and various lens sheets (e.g. lenticular lens, fry eye lens, prism sheets), and also protective sheets (protective films) which hardly serve as an optical element are included.

In order to manufacture the above optical sheet, the present invention provides a manufacturing method of optical sheet for display unit, comprising: at least one lens sheet having convex lenses which are oriented in one axial direction and arranged adjacent to each other generally over an entire surface of the lens sheet; an optical sheet laminated to a front surface and/or back surface of the lens sheet, wherein the lens sheet and the optical sheet are bonded to each other at least one or more peripheral points thereof.

In order to manufacture the above optical sheet, the present invention provides a manufacturing method of optical sheet for display unit, comprising: a laminating step for laminating an optical sheet having a flat size of a product size or more to a front surface and/or back surface of at least one lens sheet having a flat size of the product size or more and having convex lenses which are oriented in one axial direction and arranged adjacent to each other generally over an entire surface of the lens sheet; a cutting step for cutting the stack of the optical sheet and the lens sheet along its periphery into the product size; and a bonding step for bonding the lens sheet and the optical sheet to each other at least one or more peripheral points thereof.

According to the present invention, an optical sheet having a flat size of a product size or more is laminated to a front surface and/or back surface of a lens sheet having a flat size of the product size or more, and the stack is cut along its periphery into the product size, and then the lens sheet and the optical sheet are bonded to each other at least one or more peripheral points thereof.

Thus, a step for individually cutting a number of films (sheets) into a product size, and a step for aligning the number of films (sheets) for lamination are eliminated. The method of the present invention provides no problem with respect to a protective sheet, and provides an advantage of reduced cost and improved quality. Moreover, there is not any problem such as those described above in laminating a number of films, or those due to different thermal expansions/thermal shrinkages of a plurality of films.

In terms of the above advantages, according to the present invention, an optical sheet for display unit can be manufactured in simpler steps at a lower cost and with higher quality compared to conventional methods.

As used herein, the term “lens sheet having convex lenses which are oriented in one axial direction and arranged adjacent to each other generally over an entire surface of the lens sheet” includes lenticular lenses and prism sheets as well as diffraction gratings and the like.

As used herein, the term “sheet having a flat size of a product size or more” means that not only a flat size of a lens sheet or optical sheet is larger than a product size but also a flat size of a lens sheet or optical sheet may be the same with a product size. In the latter case, the lens sheet or optical sheet may not be cut along its one or more edges in the cutting step.

In order to achieve the above object, the present invention provides an optical sheet for display unit, comprising: two lens sheets having convex lenses which are oriented in one axial direction and arranged adjacent to each other generally over an entire surface of each lens sheet, the two lens sheets being laminated to each other so that the axial directions of the convex lenses on each sheet intersect with each other at a generally right angle; and an optical sheet laminated to a front surface and/or back surface of the stack of the lens sheets, wherein the two lens sheets, and the lens sheet and the optical sheet are bonded to each other at least one or more peripheral points thereof.

In order to manufacture the above optical sheet, the present invention provides a manufacturing method of optical sheet for display unit, comprising: a laminating step for laminating two lens sheets, having a flat size of a product size or more and having convex lenses which are oriented in one axial direction and arranged adjacent to each other generally over an entire surface of each lens sheet, to each other so that the axial directions of the convex lenses on each sheet intersect with each other at a generally right angle, and laminating an optical sheet having a flat size of the product size or more to a front surface and/or back surface of the stack of the lens sheets; a cutting step for cutting the stack of the optical sheet and the lens sheets along its periphery into the product size; and a bonding step for bonding the lens sheets, and the lens sheets and the optical sheet together at least one or more peripheral points thereof.

According to the present invention, the configuration with two lens sheets being laminated so that the axial directions of the convex lenses on each sheet intersect with each other at a generally right angle and an optical sheet being laminated to a front surface and/or back surface of the stack also provides the various effects as described above. Therefore, according to the present invention, an optical sheet for display unit can be manufactured in simpler steps at a lower cost and with higher quality compared to conventional methods.

Although the lens sheets are described to be laminated so that the axial directions of the convex lenses on each sheet intersect with each other at a generally right angle, the angle may be slightly adjusted to prevent Moire fringes.

In the present invention, in the bonding step, the lens sheets and/or the optical sheet are preferably fusion-bonded to each other. The lens sheets and/or optical sheet may be adhesively bonded, but fusion-bonding is preferable because it simplifies the bonding step. The lens sheets and/or optical sheet may be fusion-bonded by heating with ultrasonic waves, heating with laser beam irradiation, or the like.

In the present invention, in the bonding step, the lens sheets and/or the optical sheet are preferably adhesively bonded to each other. The lens sheets and/or optical sheet may be adhesively bonded by an adhesive as well as a double-faced adhesive tape.

In the present invention, the cutting step and the bonding step are preferably performed generally simultaneously by irradiating a laser beam. The cutting may be performed by machining (for example, shirring or stamping), but a laser beam (especially, carbon dioxide gas laser) is suitable for cutting of a resin sheet, and also is advantageous from the point of layout. In addition, the use of a laser beam allows the cutting step and the bonding step to be performed simultaneously, which preferably simplifies the steps.

In the present invention, in the bonding step, the optical sheets are preferably bonded to each other along at least one peripheral edge portion thereof. In the present invention, in the bonding step, the lens sheet and the optical sheet are preferably bonded to each other along at least one peripheral edge portion thereof.

In the present invention, in the bonding step, the lens sheets, and the lens sheets and the optical sheet are preferably bonded to each other along at least one peripheral edge portion thereof. Such bonding along at least one peripheral edge portion of the stack makes the stack more strongly fixed.

In the present invention, in the bonding step, the optical sheets are preferably bonded along four peripheral edge portions thereof. In the present invention, in the bonding step, the lens sheet and the optical sheet are preferably bonded along four peripheral edge portions thereof. In the bonding step, the lens sheets, and the lens sheets and the optical sheet are preferably bonded along four peripheral edge portions thereof. Such bonding along four peripheral edge portions makes the stack more strongly fixed, and more effectively prevents contaminants such as dust from entering.

In the present invention, the lens sheet and the optical sheet preferably have a generally similar thermal expansion coefficient. This prevents the above problems due to different thermal expansions/thermal shrinkages of films.

Specifically, a difference Δα between a thermal expansion coefficient of a lens sheet and that of an optical sheet is preferably 2% or less, more preferably 1% or less, most preferably 0.05% or less.

In order to achieve the above optical sheet, the present invention provides an optical sheet for display unit, comprising: at least one lens sheet having a flat size of a product size or more and having convex lenses which have a generally similar shape and are arranged adjacent to each other in a matrix generally over an entire surface of the lens sheet; and an optical sheet which has a flat size of the product size or more and is laminated to a front surface and/or back surface of the at least one lens sheet, wherein the lens sheet and the optical sheet are bonded to each other at least one or more peripheral points thereof.

In order to manufacture the above optical sheet, the present invention provides a manufacturing method of optical sheet for display unit, comprising: a laminating step for laminating an optical sheet having a flat size of a product size or more to a front surface and/or back surface of at least one lens sheet having a flat size of the product size or more and having convex lenses which have a generally similar shape and are arranged adjacent to each other in a matrix generally over an entire surface of the lens sheet; a cutting step for cutting the stack of the optical sheet and the lens sheet along its periphery into the product size; and a bonding step for bonding the optical sheet and the lens sheet to each other at least one or more peripheral points thereof.

According to the present invention, an optical sheet having a flat size of a product size or more is laminated to a front surface and/or back surface of a lens sheet having a flat size of the product size or more, and the stack is cut along its periphery into the product size, and then the lens sheet and the optical sheet are bonded to each other at least one or more peripheral points thereof.

Thus, a step for individually cutting a number of films (sheets) into a product size, and a step for aligning the number of films (sheets) for lamination are eliminated. The method of the present invention provides no problem with respect to a protective sheet, and provides an advantage of reduced cost and improved quality. Moreover, there is not any problem such as those described above in laminating a number of films, or those due to different thermal expansions/thermal shrinkages of a plurality of films.

In terms of the above advantages, according to the present invention, an optical sheet for display unit can be manufactured in simpler steps at a lower cost and with higher quality compared to conventional methods.

As used herein, the term “optical sheet (optical film)” may be any sheet having an optical function, including diffusion sheets, polarizers (polarizing films), and various lens sheets (e.g. lenticular lens, fry eye lens, prism sheets), and also protective sheets (protective films) which hardly serve as an optical element are included.

As used herein, the term “optical sheet having convex lenses which have a generally similar shape and are arranged adjacent to each other in a matrix generally over an entire surface of the lens sheet” may be a lens sheet having semi-spherical fry eye lenses thereon, or a lens sheet having conical convex lenses thereon, for example.

In the present invention, the convex lens preferably has a conical shape. Conical convex lens provides excellent optical performance. As used herein, the term “conical shape” means a part of space surrounded by a curved surface (or several flat surfaces) which is defined by lines between every points along a closed curved (or folded) line on a plane and a fixed point above the plane, and includes cones and pyramids.

Thus, as well as conical shape, frustum shape is also preferable in the present invention. A frustum shape means a three-dimensional space which is obtained by cutting a cone along a plane parallel to the bottom surface of the cone and taking away one cut part of the cone which has the apex of the cone. For example, a rectangular frustum means a three-dimensional space which is obtained by cutting a quadrangular pyramid along a plane parallel to the bottom surface of the quadrangular pyramid and taking away one cut part of the cone which has the apex of the quadrangular pyramid.

In the present invention, the optical sheet is preferably a diffusion sheet. An optical sheet for display unit having a diffusion sheet and the above described lens sheet will provide a preferable optical performance.

As used herein, the term “sheet having a flat size of a product size or more” means that not only a flat size of a lens sheet or diffusion sheet is larger than a product size but also a flat size of a lens sheet or diffusion sheet may be the same with a product size. In the latter case, the lens sheet or diffusion sheet may not be cut along its one or more edges in the cutting step.

In the present invention, in the bonding step, the lens sheets and/or the optical sheet are preferably fusion-bonded to each other. The lens sheets and/or optical sheet may be adhesively bonded, but fusion-bonding is preferable because it simplifies the bonding step. The lens sheets and/or optical sheet may be fusion-bonded by heating with ultrasonic waves, heating with laser beam irradiation, or the like.

In the present invention, in the bonding step, the lens sheets and/or the optical sheet are preferably adhesively bonded to each other. The lens sheets and/or optical sheet may be adhesively bonded by an adhesive as well as a double-faced adhesive tape.

In the present invention, the cutting step and the bonding step are preferably performed generally simultaneously by irradiating a laser beam. The cutting may be performed by machining (for example, shirring or stamping), but a laser beam (especially, carbon dioxide gas laser) is suitable for cutting of a resin sheet, and also is advantageous from the point of layout. In addition, the use of a laser beam allows the cutting step and the bonding step to be performed simultaneously, which preferably simplifies the steps.

In the present invention, in the bonding step, the lens sheets and/or the optical sheet are preferably bonded along at least one peripheral edge portion thereof. Such bonding along at least one peripheral edge portion of the stack makes the stack more strongly fixed.

In the present invention, in the bonding step, the lens sheets and/or the optical sheet are preferably bonded to each other along four peripheral edge portions thereof. Such bonding along four peripheral edge portions makes the stack more strongly fixed, and more effectively prevents contaminants such as dust from entering between the sheets.

In the present invention, the lens sheets and/or the optical sheet preferably have a generally similar thermal expansion coefficient. This prevents the above problems due to different thermal expansions/thermal shrinkages of films.

Specifically, a difference Δα between a thermal expansion coefficient of a lens sheet and that of an optical sheet is preferably 2% or less, more preferably 1% or less, most preferably 0.05% or less.

### ADVANTAGES OF THE INVENTION

As described above, according to the present invention, an optical sheet for display unit can be manufactured in simpler steps at a lower cost and with higher quality compared to conventional methods.

### BRIEF DESCRIPTION OF THE DRAWINGS

FIG. 1 is a cross sectional view showing an embodiment of an optical sheet for display unit manufactured by a manufacturing method of optical sheet for display unit according to a first aspect of the present invention;

FIG. 2 is a cross sectional view showing another embodiment of optical sheet according to the first aspect of the present invention;

FIG. 3 is a cross sectional view showing further another embodiment of optical sheet according to the first aspect of the present invention;

FIG. 4 is a cross sectional view showing further another embodiment of optical sheet according to the first aspect of the present invention;

FIG. 5 is a cross sectional view showing further another embodiment of optical sheet according to the first aspect of the present invention;

FIG. 6 is a cross sectional view showing further another embodiment of optical sheet according to the first aspect of the present invention;

FIG. 7 is a view showing a configuration of a manufacturing line for an optical sheet for display unit which is applied to first, seventh, and thirteenth manufacturing methods;

FIG. 8 is a view showing a configuration of a manufacturing line for an optical sheet for display unit which is applied to second, eighth, and fourteenth manufacturing methods;

FIG. 9 is a view showing a configuration of a manufacturing line for an optical sheet for display unit which is applied to third, ninth, and fifteenth manufacturing methods;

FIG. 10 is a view showing a configuration of a manufacturing line for an optical sheet for display unit which is applied to fourth, tenth, and sixteenth manufacturing methods;

FIG. 11 is a view showing a configuration of a manufacturing line for an optical sheet for display unit which is applied to fifth, eleventh, and seventeenth manufacturing methods;

FIG. 12 is a view showing a configuration of a manufacturing line for an optical sheet for display unit which is applied to sixth, twelfth, and eighteenth manufacturing methods;

FIGS. 13A and 13B are views illustrating a plane configuration of sheets to be punched out of a stack in first, seventh, and thirteenth manufacturing methods

FIGS. 14A and 14B are views illustrating a plane configuration of sheets to be punched out of a stack in second to sixth, eighth to twelfth, and fourteenth to eighteenth manufacturing methods;

FIG. 15 is a chart showing a composition of a resin solution which is used to fabricate a prism sheet;

FIG. 16 is a view showing a configuration of an apparatus for manufacturing a prism sheet;

FIG. 17 is a cross sectional view showing an embodiment of an optical sheet for display unit manufactured by a manufacturing method of optical sheet for display unit according to a second aspect of the present invention;

FIG. 18 is a cross sectional view showing another embodiment of optical sheet according to the second aspect of the present invention;

FIG. 19 is a cross sectional view showing further another embodiment of optical sheet according to the second aspect of the present invention;

FIG. 20 is a cross sectional view showing further another embodiment of optical sheet according to the second aspect of the present invention;

FIG. 21 is a cross sectional view showing further another embodiment of optical sheet according to the second aspect of the present invention;

FIG. 22 is a cross sectional view showing an embodiment of an optical sheet for display unit manufactured by a manufacturing method of optical sheet for display unit according to a third aspect of the present invention;

FIG. 23 is a cross sectional view showing another embodiment of optical sheet according to the third aspect of the present invention; and

FIG. 24 is a cross sectional view showing further another embodiment of optical sheet according to the third aspect of the present invention.

### DESCRIPTION OF SYMBOLS

10, 20, 30, 40 . . . optical sheet for display unit
12 . . . first diffusion sheet
14 . . . first prism sheet
16 . . . second prism sheet
18 . . . second diffusion sheet
110, 120, 130 . . . optical sheet for display unit
112 . . . first optical sheet
114 . . . prism sheet
116 . . . second optical sheet
118 . . . protective sheet
210, 220, 230 . . . optical sheet for display unit
212 . . . first diffusion sheet
214 . . . prism sheet
216 . . . second diffusion sheet
218 . . . optical sheet

### BEST MODE OF CARRYING OUT THE INVENTION

### [First Aspect]

Now, a first aspect of the present invention will be explained with reference to accompanying drawings. First, several exemplary optical sheets for display unit (First to Sixth embodiments) which are manufactured by a manufacturing method of optical sheet for display unit according to the present invention will be explained, and then several manufacturing methods (First to Sixth manufacturing methods) of these optical sheets for display unit will be explained.

### Embodiments of First Aspect

### First Embodiment

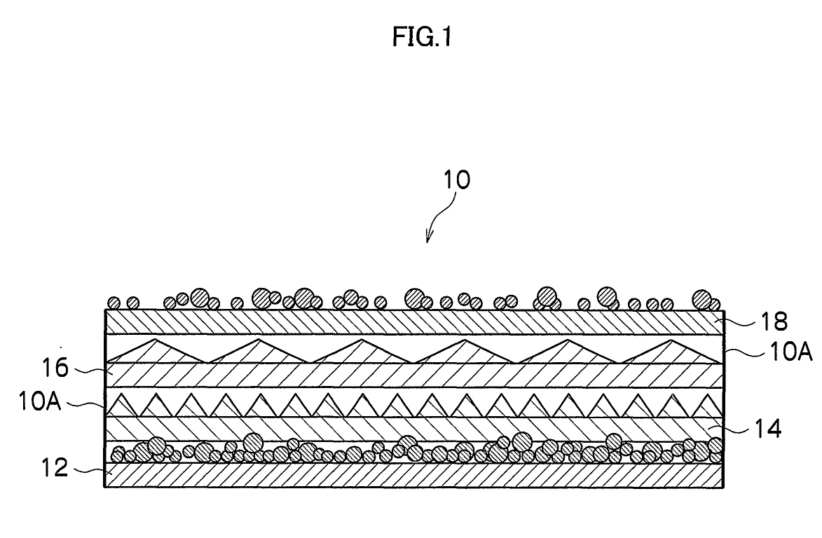

FIG. 1 is a cross sectional view showing a configuration of an optical sheet for display unit (First Embodiment) manufactured by a manufacturing method of optical sheet for display unit according to the present invention.

An optical sheet for display unit 10 is a module of an optical sheet including, in order from the bottom, a first diffusion sheet 12, a first prism sheet 14, a second prism sheet 16, and a second diffusion sheet 18 which are laminated to each other.

Each of the first diffusion sheet 12 and the second diffusion sheet 18 is made of a transparent film (substrate) having a surface (one of the surfaces) on which beads are held by a binder, and has a predetermined light diffusing property. The first diffusion sheet 12 and the second diffusion sheet 18 have beads thereon of different diameters (mean particle sizes), and different light diffusing properties from each other.

The transparent film (substrate) used for each of the first diffusion sheet 12 and the second diffusion sheet 18 may be a resin film. The resin film may be made of known materials such as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), biaxially stretched polyethylene terephthalate, polyethylene naphthalate, polyamideimide, polyimide, aromatic polyamide, cellulose acrylate, cellulose triacetate, cellulose acetate propionate, and cellulose diacetate. Among these, polyester, cellulose acrylate, acryl, polycarbonate, and polyolefin are especially preferable.

The first diffusion sheet 12 and the second diffusion sheet 18 should have beads having a diameter of 100 μm or less, and preferably 25 μm or less. For example, the first diffusion sheet 12 and the second diffusion sheet 18 may have beads having a diameter within a predetermined range of 7 to 38 μm, with a mean particle size of 17 μm.

The first prism sheet 14 and the second prism sheet 16 are lens sheets having convex lenses which are oriented in one axial direction and arranged adjacent to each other generally over an entire surface of each lens sheet. For example, the lenses may have a pitch of 50 μm, a height of concave-convex structure of 25 μm, and an apex angle of 90 degrees (right angle).

The first prism sheet 14 and the second prism sheet 16 are arranged so that the axial directions of the convex lenses (prisms) on each sheet intersect with each other at a generally right angle. In other words, in FIG. 1, the axis of the convex lenses on the first prism sheet 14 extends in a vertical direction relative to the paper, and the axis of the convex lenses on the second prism sheet 16 extends in a horizontal direction relative to the paper. However, in FIG. 1, the convex lenses on the second prism sheet 16 are shown in a different direction from the actual direction so that it can be understood that the second prism sheet 16 has a cross section of the convex lens shape.

The first prism sheet 14 and the second prism sheet 16 may be made of any known material by any manufacturing method. For example, a manufacturing method of a resin sheet may be used, in which a resin material is extruded from a die, and the material is pressed between a transfer roller (having a pattern on its surface that is a reversed pattern of a prism sheet) which rotates at a generally same speed with an extruding speed of the resin material and a nip roller which is positioned opposite to the transfer roller and rotates at the same speed, so that the pattern on the surface of the transfer roller is transferred to the resin material.

Alternatively, a manufacturing method of a resin sheet may be used, in which a plate (stamper) having a pattern formed on its surface which is a reversed pattern of a prism sheet is laminated onto a resin plate by hot press, and the pattern is press formed on the resin plate by thermal transfer.

The resin materials for use in these manufacturing methods may be a thermoplastic resin such as polymethylmethacrylate resin (PMMA), polycarbonate resin, polystyrene resin, MS resin, AS resin, polypropylene resin, polyethylene resin, polyethylene terephthalate resin, polyvinyl chloride resin (PVC), thermoplastic elastomers and their copolymers, and cycloolefinpolymer.

Alternatively, a manufacturing method of a resin sheet may be used, in which a concavo-convex roller (having a pattern on its surface which is a reversed pattern of a prism sheet) is used to transfer the concavo-convex pattern on its surface onto a surface of a transparent film (e.g. polyester, cellulose acrylate, acryl, polycarbonate, polyolefin) of a similar type to that for the film for the first diffusion sheet 12 and the second diffusion sheet 18.

More specifically, a manufacturing method of concavo-convex sheet may be used, in which an adhesive and a resin are serially coated onto a surface of a transparent film to achieve a film having two or more layers of an adhesive layer and a resin layer (e.g. UV curing resin), and the transparent film continuously travels to be wound around a rotating concavo-convex roller so that a concavo-convex pattern on a surface of the concavo-convex roller is transferred to the resin layer and the resin layer is cured while being wound around the concavo-convex roller (for example, by UV irradiation). The adhesive may not be used.

The manufacturing methods of the first prism sheet 14 and the second prism sheet 16 are not limited to those described above, and other methods may be used in which a desired concavo-convex shape can be formed on a surface of a sheet.

As shown in FIG. 1, at the right and left ends of the optical sheet for display unit 10, bonding sections 10A are formed to connect the layers. The bonding sections 10A are formed by a carbon dioxide gas laser irradiation or the like in the bonding step.

The optical sheet for display unit 10 is used to be disposed, for example, between a light source apparatus and liquid crystal cells, thereby forming a liquid crystal display unit as a whole. With the use of the optical sheet for display unit 10, in addition to the various advantages described above (an optical sheet for display unit can be manufactured in simpler steps at a lower cost and with higher quality compared to conventional methods), there is provided another advantage that the liquid crystal display unit can be quite easily assembled.

### Second Embodiment

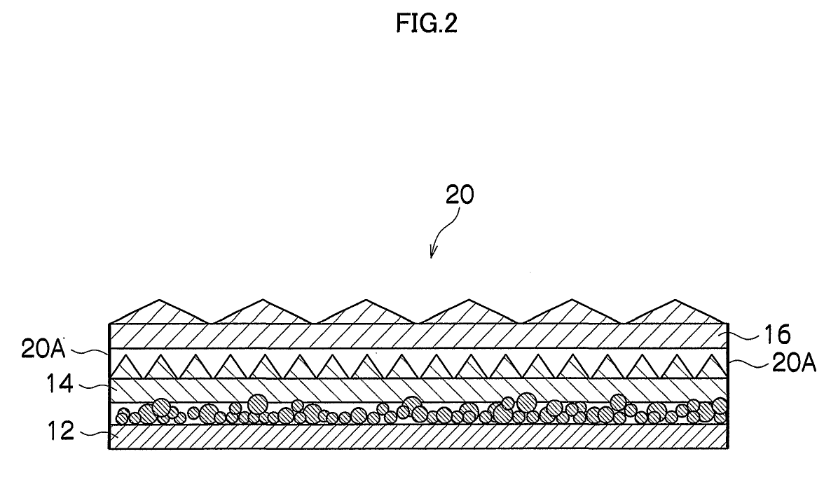

Next, another optical sheet for display unit (Second Embodiment) manufactured by a manufacturing method for according to the present invention will be explained. FIG. 2 is a cross sectional view showing a configuration of an optical sheet for display unit 20. Members in FIG. 2 which are the same or similar to those in FIG. 1 (First Embodiment) are designated with like reference numerals, and will not be explained in detail below.

The optical sheet for display unit 20 includes, in order from the bottom, a diffusion sheet 12, a first prism sheet 14, and a second prism sheet 16 which are laminated to each other. The optical sheet for display unit 20 does not include a second diffusion sheet 18 because a diffusing property for a wide area, like that of the optical sheet for display unit 10, is not required.

The optical sheet for display unit 20 is used to be disposed, for example, between a light source apparatus and liquid crystal cells, thereby forming a liquid crystal display unit as a whole, as in First Embodiment.

### Third Embodiment

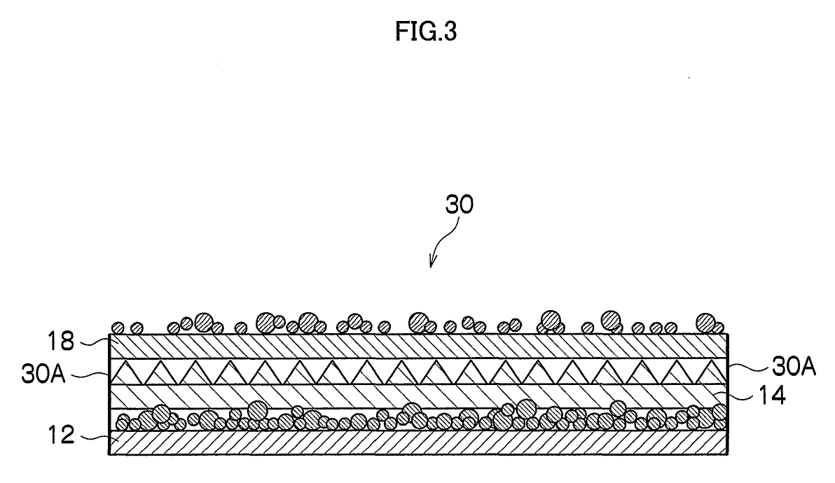

Next, further another optical sheet for display unit (Third Embodiment) manufactured by a manufacturing method for according to the present invention will be explained. FIG. 3 is a cross sectional view showing a configuration of an optical sheet for display unit 30. Members in FIG. 3 which are the same or similar to those in FIG. 1 (First Embodiment) and FIG. 2 (Second Embodiment) are designated with like reference numerals, and will not be explained in detail below.

The optical sheet for display unit 30 includes, in order from the bottom, a first diffusion sheet 12, a prism sheet 14, and a second diffusion sheet 18 which are laminated to each other.

The optical sheet for display unit 30 does not include a second prism sheet 16 because a diffusing property in a direction which is vertical to the paper of FIG. 2, like that of the optical sheet for display unit 10, is not required.

The optical sheet for display unit 30 is used to be disposed, for example, between a light source apparatus and liquid crystal cells, thereby forming a liquid crystal display unit as a whole, as in First Embodiment.

### Fourth Embodiment

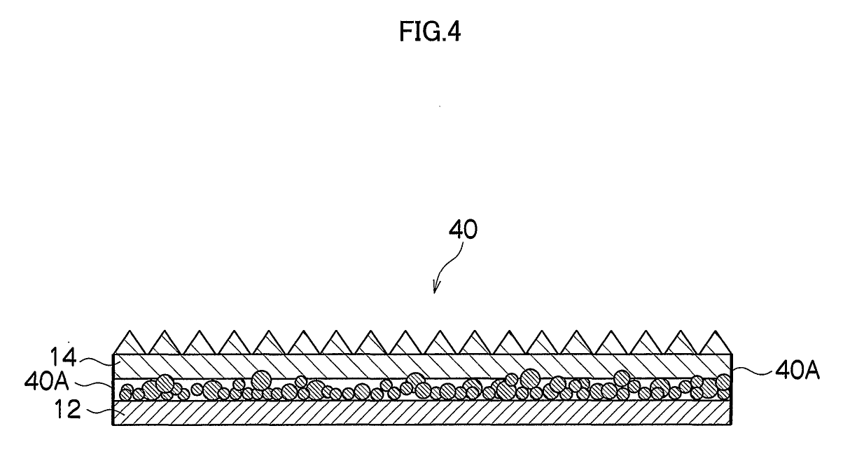

Next, further another optical sheet for display unit (Fourth Embodiment) manufactured by a manufacturing method for according to the present invention will be explained. FIG. 4 is a cross sectional view showing a configuration of an optical sheet for display unit 40. Members in FIG. 4 which are the same or similar to those in FIG. 1 (First Embodiment), FIG. 2 (Second Embodiment) and the like are designated with like reference numerals, and will not be explained in detail below.

The optical sheet for display unit 40 includes, in order from the bottom, a diffusion sheet 12, and a prism sheet 14 which are laminated to each other. The optical sheet for display unit 40 does not include a second diffusion sheet 18 because a diffusing property for a wide area like that of the optical sheet for display unit 10 is not required, and does not include a second prism sheet 16 because a diffusing property in a direction which is vertical to the paper of FIG. 4 like that of the optical sheet for display unit 10 is not required.

The optical sheet for display unit 40 is used to be disposed, for example, between a light source apparatus and liquid crystal cells, thereby forming a liquid crystal display unit as a whole, as in First Embodiment.

### Fifth Embodiment

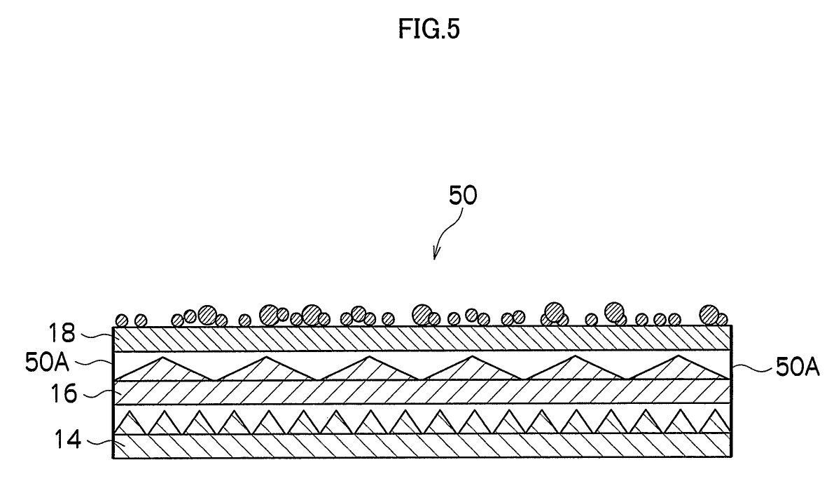

Next, another optical sheet for display unit (Fifth Embodiment) manufactured by a manufacturing method for according to the present invention will be explained. FIG. 5 is a cross sectional view showing a configuration of an optical sheet for display unit 50. Members in FIG. 5 which are the same or similar to those in FIG. 1 (First Embodiment), FIG. 2 (Second Embodiment) and the like are designated with like reference numerals, and will not be explained in detail below.

The optical sheet for display unit 50 includes, in order from the bottom, and a first prism sheet 14, a second prism sheet 16, and a diffusion sheet 18 which are laminated to each other. The optical sheet for display unit 50 does not include a first diffusion sheet 12 because a diffusing property for a wide area like that of the optical sheet for display unit 10 is not required.

The optical sheet for display unit 50 is used to be disposed, for example, between a light source apparatus and liquid crystal cells, thereby forming a liquid crystal display unit as a whole, as in First Embodiment.

### Sixth Embodiment

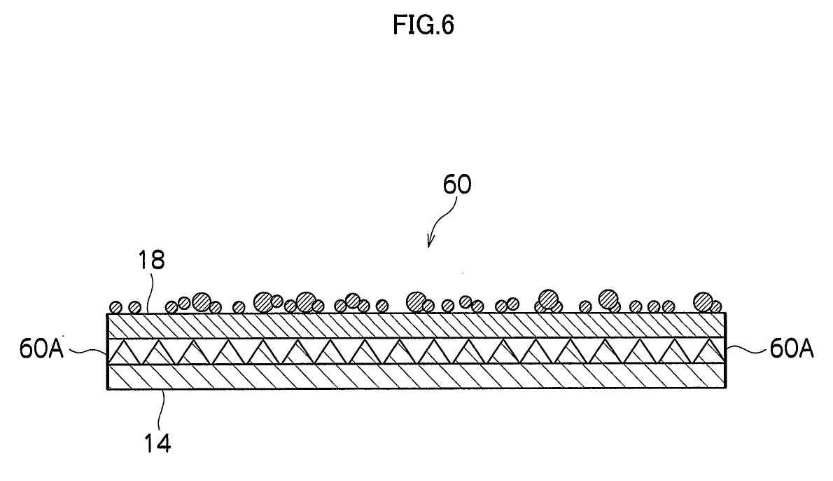

Next, another optical sheet for display unit (Sixth Embodiment) manufactured by a manufacturing method for according to the present invention will be explained. FIG. 6 is a cross sectional view showing a configuration of an optical sheet for display unit 60. Members in FIG. 6 which are the same or similar to those in FIG. 1 (First Embodiment), FIG. 2 (Second Embodiment) and the like are designated with like reference numerals, and will not be explained in detail below.

The optical sheet for display unit 60 includes, in order from the bottom, a first prism sheet 14 and a diffusion sheet 18 which are laminated to each other. The optical sheet for display unit 60 does not include a first diffusion sheet 12 because a diffusing property for a wide area like that of the optical sheet for display unit 10 is not required, and does not include a second prism sheet 16 because a diffusing property in a direction which is vertical to the paper of FIG. 6 like that of the optical sheet for display unit 10 is not required.

The optical sheet for display unit 60 is used to be disposed, for example, between a light source apparatus and liquid crystal cells, thereby forming a liquid crystal display unit as a whole, as in First Embodiment.

### [Manufacturing Methods According to First Aspect]

Now, several manufacturing methods for optical sheets for display unit (First to Sixth Manufacturing Methods) will be explained. These manufacturing methods may be commonly used for the optical sheets for display unit 10 to 60, but for simplicity of explanation, only embodiments in which the manufacturing methods are applied to an optical sheet for display unit including four laminated layers (First Embodiment).

### (First Manufacturing Method)

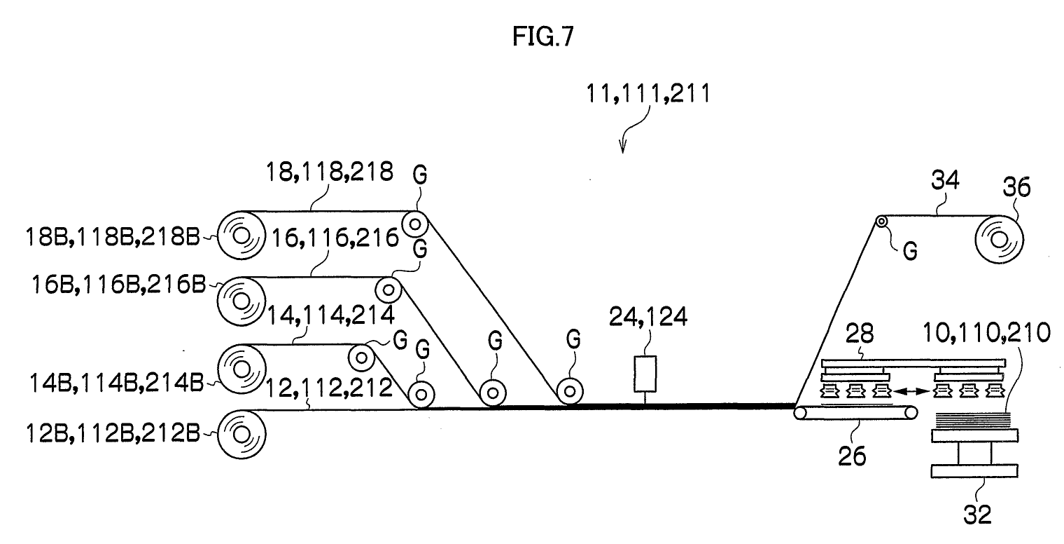

FIG. 7 is a view showing a configuration of a manufacturing line 11 for an optical sheet for display unit which is applied to a first manufacturing method. The first diffusion sheet 12, the first prism sheet 14, the second prism sheet 16, and the second diffusion sheet 18 shown in FIG. 1 are wound around rolls 12B, 14B, 16B, and 18B at the left end of FIG. 7, respectively.

Each of the rolls 12B, 14B, 16B, and 18B are supported by a rotary shaft of supply means (not shown), and the first diffusion sheet 12, the first prism sheet 14, the second prism sheet 16, and the second diffusion sheet 18 can be supplied from the rolls 12B, 14B, 16B, and 18B respectively at a generally same speed.

After being supplied, the first diffusion sheet 12, the first prism sheet 14, the second prism sheet 16, and the second diffusion sheet 18 are supported by a guide rollers G respectively, to be laminated to each other upstream of a laser head 24 which will be explained below (laminating step).

The laser head 24 is included in a laser beam generating apparatus which may be a YAG laser irradiation apparatus having a wavelength of 355 to 1064 nm, a semiconductor laser irradiation apparatus, a carbon dioxide gas laser irradiation apparatus having a wavelength of 9 to 11 μm, and the like. The lasers may be irradiated as a continuous laser beam or a pulsed laser beam, but when a cutting and a fusion-bonding are performed generally simultaneously, spot welding with a pulsed laser beam provides an excellent finish and is preferable.

The size of power and frequency of a laser beam required to generally simultaneously perform a cutting (cutting step) and a fusion-bonding (bonding step) depends on a feeding speed of sheet materials, a scanning speed of a laser beam, a thickness of sheet materials, and the like, but generally, a good result can be obtained under a condition where a power of 2 to 50 W and a frequency of 100 kHz or less are used.

The laser head 24 is mounted to a shaft of an X drive robot which is movable in the X direction (the direction along a sheet width) or an XY drive robot which is movable in the X and Y directions, and can be aligned at any position and can be moved along any trajectory. The laser head 24 itself may be moved corresponding to an irradiation pattern of laser beam, but with the laser head 24 being separately disposed (fixed), only a laser beam may be waveguided by an optical fiber so that the movement mechanism in the XY direction can be simplified.

A known mechanism (e.g. aspiration apparatus) for aspiration of smoke which is produced in cutting and fusion-bonding sheets by the laser head 24 may be provided.

The laser head 24 irradiates a laser beam to a cut and bonded portion of the periphery of a stack of sheets, and moves irradiated spots on the stack at a constant speed so that the stack along can be cut along its periphery into a product size and at the same time can be fusion-bonded along its periphery.

After the above steps are completed, the optical sheet for display unit 10 (see FIG. 1) is formed. The cut and bonded optical sheet for display unit 10 is transported to a conveyer 26, where the sheet 10 is held. The optical sheet for display unit 10 held on the conveyer 26 is sucked by a lateral transfer apparatus 28 and is piled up on an accumulation apparatus 32 one by one.

The stack 34 out of which the optical sheets for display unit 10 were punched by the laser head 24 is wound onto a winding roll 36 of a winding apparatus (not shown in detail).

According to the manufacturing method for optical sheets for display unit (First Manufacturing Method), the following effects 1 to 3 are achieved.

1) Effect on Reducing Damage and Failure

Any damage on front and back surfaces of lens sheets (the first prism sheet 14, the second prism sheet 16) is a distinct deficit due to its own lens effect. To the contrary, any damage on the back surfaces of diffusion sheets (the first diffusion sheet 12, the second diffusion sheet 18) is not so distinct because light is diffused. Therefore, prevention of damage on lens sheets provides an effect to reduce damage and failure of an optical sheet. Damages on a lens sheet is often incurred in handling after the lens sheet is processed, but in the combination of a lens sheet and a diffusion sheet, the diffusion sheet serves as a protective sheet, which reduces the failures due to damages. Especially, this effect is better achieved in the optical sheet for display unit 10 of the first embodiment (see FIG. 1) and the optical sheet for display unit 30 of the third embodiment (see FIG. 3) in which lens sheets are not exposed as front surfaces.

2) Effect on Reducing the Number of Assembly Steps

For example, in assembling of a liquid crystal display unit, with use of the optical sheet for display unit 10 of the first embodiment, only one step for installing the optical sheet for display unit 10 in is required, while with use of conventional article, eight steps are required: (i) installing of a first diffusion sheet; (ii) peeling of a back protective sheet of a first lens sheet; (iii) peeling of a front protective sheet of the first lens sheet; (iv) installing of the first lens sheet; (v) peeling of a back protective sheet of a second lens sheet; (vi) peeling of a front protective sheet of the second lens sheet; (vii) installing of the second lens sheet; (viii) and install of a second diffusion sheet. Thus, according to the first manufacturing method, the number of assembly steps can be significantly reduced, which reduces final product cost.

3) Effect on Reducing of Protective Sheet

Lens sheets usually have protective sheets attached to the front and back surfaces thereof for prevention of damages. After the install of the lens sheets, the protective sheets are discarded, which is a huge waste of resources. In an optical sheet for display unit according to the present invention, a diffusion sheet serves as a protective sheet to save a protective sheet.

Specifically, one protective sheet can be saved in the optical sheet for display unit 40 of the fourth embodiment (see FIG. 4) and the optical sheet for display unit 60 of the sixth embodiment (see FIG. 6), two protective sheets can be saved in the optical sheet for display unit 30 of the third embodiment (see FIG. 3), three protective sheets can be saved in the optical sheet for display unit 20 of the second embodiment (see FIG. 2) and the optical sheet for display unit 50 of the fifth embodiment (see FIG. 5), and four protective sheets can be saved in the optical sheet for display unit 10 of the first embodiment (see FIG. 1).

### (Second Manufacturing Method)

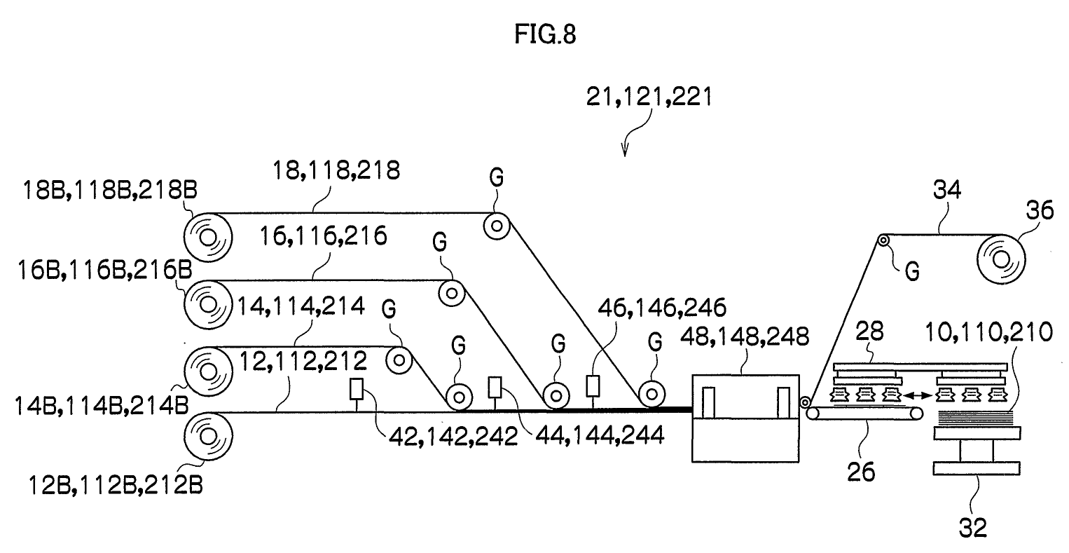

Now, another manufacturing method for optical sheets for display unit (Second Manufacturing Method) will be explained. FIG. 8 is a view showing a configuration of a manufacturing line 21 for optical sheets for display unit which is applied to a second manufacturing method. Members in FIG. 8 which are the same or similar to those in the manufacturing line 11 for optical sheets for display unit in FIG. 7 (First Manufacturing Method) are designated with like reference numerals, and will not be explained in detail below.

A manufacturing line 21 for optical sheets for display unit is provided with dispensers 42, 44, and 46 and a punch press apparatus 48 in stead of the laser head 24 in the manufacturing line 11 for optical sheets for display unit.

The dispensers 42, 44, and 46 are suppliers for separately discharging an adhesive from each distal end thereof. The dispenser 42 supplies an adhesive to a front surface of a first diffusion sheet 12 to adhere the first diffusion sheet 12 and a first prism sheet 14 together, the dispenser 44 supplies an adhesive to a front surface of the first prism sheet 14 to adhere the first prism sheet 14 and a second prism sheet 16 together, and the dispenser 46 supplies an adhesive to a front surface of the second prism sheet 16 to adhere the second prism sheet 16 and a second diffusion sheet 18 together.

The adhesives supplied from the dispensers 42, 44, and 46 are preferably of a type which works with the aid of heat or catalyst. Specifically, general adhesives including silicon adhesives, polyurethane adhesives, polyester adhesives, epoxy adhesives, cyanoacrylate adhesives, and acrylic adhesives may be used.

The adhesives are preferably stable at a temperature in a range of room temperature to 120° C. since the optical sheets for display unit 10 to 60 may be used at a high temperature. Among those listed above, epoxy adhesives are preferable to use for their excellent strength and heat resistance. Cyanoacrylate adhesives are preferable to the use in an efficient fabrication of optical sheets for display unit for their excellent quick effect and strength. Polyester adhesives are especially preferable for their excellent strength and processability.

The adhesives can be broadly divided into three categories: heat curing type, hot melt type, and binary liquid mixture type, and the adhesives of heat curing type or hot melt type are preferably to use which allow production processes to be continuously operated. Regardless of the type of adhesives to be used, a coating thickness of an adhesive is preferably 0.5 μm to 50 μm.

Preferably, drying means for drying the adhesives are provided before a press roller (guide roller G) arranged downstream of the dispensers. The drying means may be any known drying approaches, without specific limitation, such as drying with warm or hot air, drying with dehumidified air, and the like.

Each of the dispensers 42, 44, and 46 are mounted to a shaft of an X drive robot which is movable in the X direction (the direction along a sheet width) or an XY drive robot which is movable in the X and Y directions, and can be aligned at any position and can be moved along any trajectory.

The dispensers 42, 44, and 46 supply adhesives to the peripheral portions of a stack to be bonded, so that the press roller (guide roller G) downstream of the dispensers 42, 44, and 46 bonds the peripheral portions of the stack while the stack is transported.

A punch press apparatus 48 is located downstream of the dispensers 42, 44, and 46, and cuts the stack along its periphery into a product size. The punch press apparatus 48 has a cutting edge, and the cutting edge is put into the center of the bonded peripheral portions of a stack to punch out a sheet (the optical sheets for display unit 10 to 60) so that a composite sheet in which only edge portions of all sides or any selected sides thereof are bonded can be obtained.

### (Third Manufacturing Method)

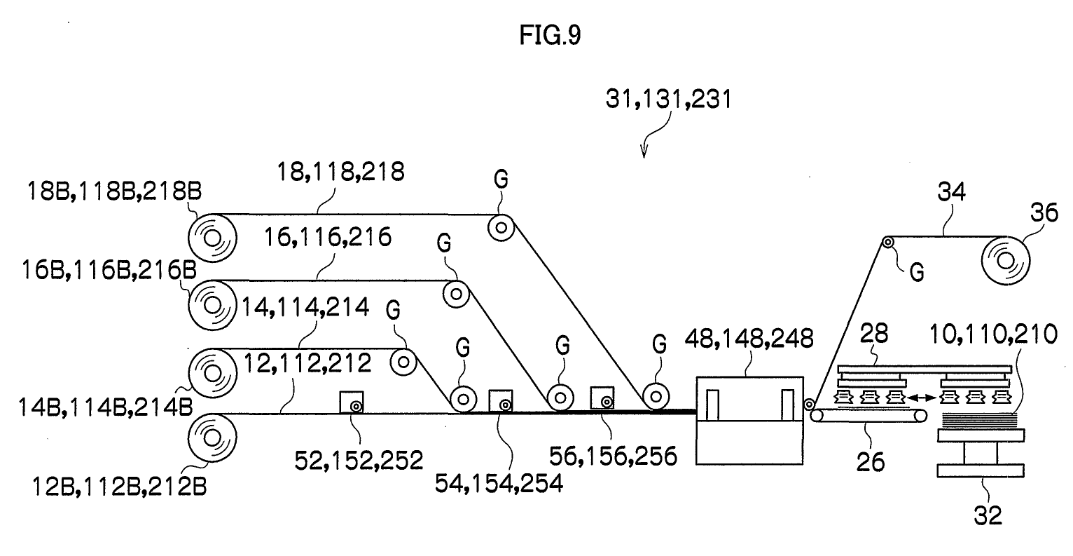

Now, further another manufacturing method for optical sheets for display unit (Third Manufacturing Method) will be explained. FIG. 9 is a view showing a configuration of a manufacturing line 31 for optical sheets for display unit which is applied to a third manufacturing method. Members in FIG. 9 which are the same or similar to those in the manufacturing line 11 for optical sheets for display unit in FIG. 7 (First Manufacturing Method) and those in the manufacturing line 21 for optical sheets for display unit in FIG. 8 (Second Manufacturing Method) are designated with like reference numerals, and will not be explained in detail below.

The manufacturing line 21 for optical sheets for display unit is provided with tape dispensing apparatuses 52, 54, and 56 instead of the dispensers 42, 44, and 46 in the manufacturing line 21 for optical sheets for display unit. The tape dispensing apparatuses 52, 54, and 56 separately supply a two-sided tape from each distal end thereof.

The tape dispensing apparatus 52 supplies a two-sided tape to a front surface of the first diffusion sheet 12 to adhere the first diffusion sheet 12 and the first prism sheet 14 together, the tape dispensing apparatus 54 supplies a two-sided tape to a front surface of a first prism sheet 14 to adhere the first prism sheet 14 and a second prism sheet 16 together, and the tape dispensing apparatus 56 supplies a two-sided tape to a front surface of the second prism sheet 16 to adhere the second prism sheet 16 and a second diffusion sheet 18 together.

Each of the two-sided tapes supplied from the tape dispensing apparatuses 52, 54, and 56 has front and back surfaces to which a glue agent is coated. The glue agents for two-sided tapes may be acrylic copolymer resin of high gluing property, as well as glue agents of silicon base, natural rubber base, synthetic rubber base, for example, and acrylic glue agents are comprehensively preferable from a viewpoint of physical strength including heat resistance and creep resistance, costs, and the like.

The tape dispensing apparatuses 52, 54, and 56 for supplying two-sided tapes may be any general-purpose tape dispensers which are commercially available. Each of the tape dispensing apparatuses 52, 54, and 56 are mounted to a uniaxial moving mechanism which is movable to any points in the X direction (the direction along a sheet width), and can change the positions to put two-sided tapes corresponding to a punching pattern.

Each of the tape dispensing apparatuses 52, 54, and 56 is fixed by a fixing section having a pivot mechanism which changes the position of each tape dispensing apparatuses 52, 54, and 56 in synchronizing with the sheet feeding speed so as to put the two-sided tapes in an oblique direction relative to the tape travel path.

A punch press apparatus 48 is located downstream of the tape dispensing apparatuses 52, 54, and 56, and cuts the stack along its periphery into a product size. The punch press apparatus 48 has a cutting edge, and the cutting edge is put into the center of the bonded peripheral portions of a stack to punch out a sheet (the optical sheets for display unit 10 to 60) so that a composite sheet in which only edge portions of all sides or any selected sides thereof are bonded can be obtained.

### (Fourth Manufacturing Method)

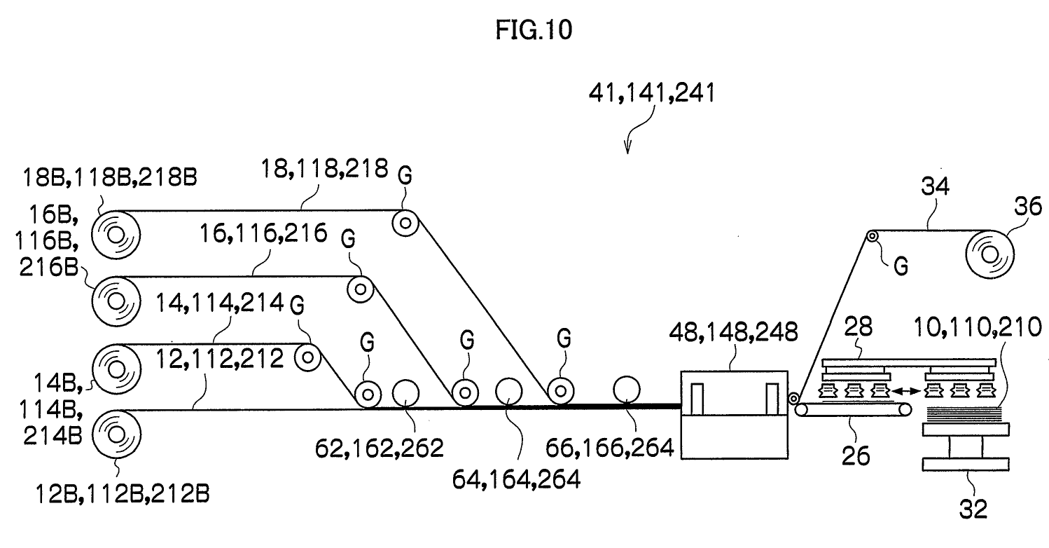

Now, further another manufacturing method for optical sheets for display unit (Fourth Manufacturing Method) will be explained. FIG. 10 is a view showing a configuration of a manufacturing line 41 for optical sheets for display unit which is applied to a fourth manufacturing method. Members in FIG. 10 which are the same or similar to those in the manufacturing line 11 for optical sheets for display unit in FIG. 7 (First Manufacturing Method), those in the manufacturing line 21 for optical sheets for display unit in FIG. 8 (Second Manufacturing Method) and those in the manufacturing line 31 for optical sheets for display unit in FIG. 9 (Third Manufacturing Method) are designated with like reference numerals, and will not be explained in detail below.

The manufacturing line 21 for optical sheets for display unit is provided with ultrasonic horns 62, 64, and 66 instead of the dispensers 42, 44, and 46 in the manufacturing line 21 for optical sheets for display unit. Each of the ultrasonic horns 62, 64, and 66 is located downstream of a press roller (guide roller G).

The ultrasonic horns 62, 64, and 66 fusion bond two or more laminated sheets to each other. The ultrasonic horn 62 fusion bonds a first diffusion sheet 12 and a first prism sheet 14 to each other, the ultrasonic horn 64 fusion bonds a first prism sheet 14 and a second prism sheet 16 to each other, and the ultrasonic horn 66 fusion bonds a second prism sheet 16 and a second diffusion sheet 18 to each other.

Ultrasonic horns (ultrasonic bonding apparatuses) having an air cylinder for lifting a horn or those having a servomotor for lifting a horn have been known in the prior art, but the ultrasonic horns 62, 64, and 66 may be any type of ultrasonic bonding apparatus which is able to fusion bond the sheets to each other by applying ultrasonic vibration to the sheets while a load is applied to the sheets.

The ultrasonic horns 62, 64, and 66 are controlled to change their positions in a sheet width direction when the sheets are punched in a horizontal pattern relative to a sheet feeding direction, and when the sheets are punched in an oblique pattern relative to the sheet feeding direction, the ultrasonic horns 62, 64, and 66 need to be provided with a swingable mechanism for changing the direction of travel of each ultrasonic horns 62, 64, and 66 so as to move in the sheet width direction in synchronizing with a sheet travel distance.

The ultrasonic horns 62, 64, and 66 may be set to operate under any condition as far as no bonded portions melt by heat to be split, and a cooling mechanism may be provided to cool the connected (fusion bonded) portions of sheets by blowing air or the like after the sheets are connected, as needed.

A punch press apparatus 48 is located downstream of the ultrasonic horns 62, 64, and 66. The punch press apparatus 48 has a cutting edge, and the cutting edge is put into the center of the fusion bonded portions to punch out a sheet (the optical sheets for display unit 10 to 60) so that a composite sheet in which only edge portions of all sides or any selected sides thereof are bonded can be obtained.

### (Fifth Manufacturing Method)

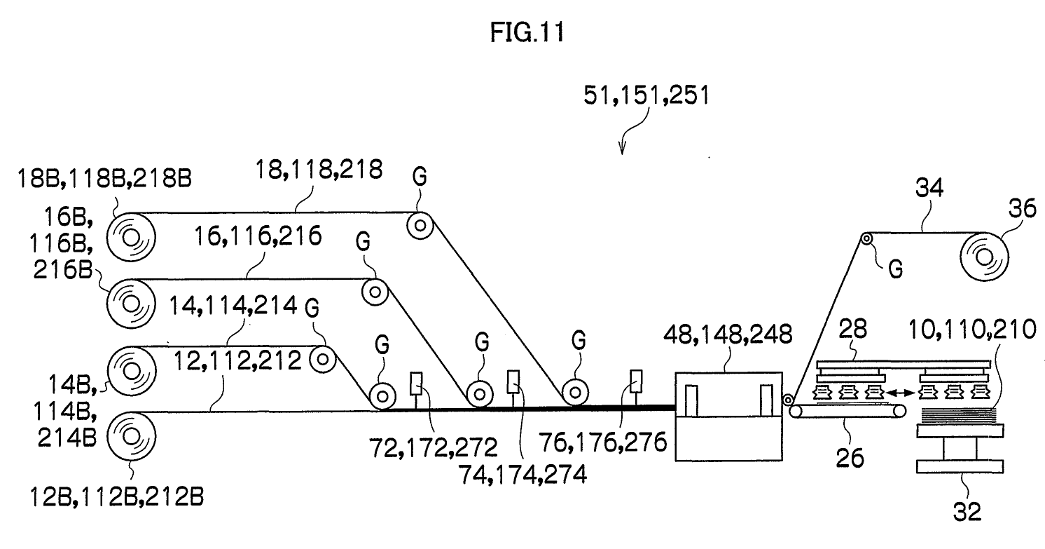

Now, further another manufacturing method for optical sheets for display unit (Fifth Manufacturing Method) will be explained. FIG. 11 is a view showing a configuration of a manufacturing line 51 for optical sheets for display unit which is applied to a fifth manufacturing method. Members in FIG. 11 which are the same or similar to those in the manufacturing line 11 for optical sheets for display unit in FIG. 7 (First Manufacturing Method), those in the manufacturing line 21 for optical sheets for display unit in FIG. 8 (Second Manufacturing Method) and those in the manufacturing line 31 for optical sheets for display unit in FIG. 9 (Third Manufacturing Method) and the like are designated with like reference numerals, and will not be explained in detail below.

The manufacturing line 51 for optical sheets for display unit is provided with laser heads 72, 74, and 76 instead of the ultrasonic horns 62, 64, and 66 in the optical sheet for display unit manufacturing line 41. Similar to the ultrasonic horns 62, 64, and 66, the laser head 72, 74, and 76 are located downstream of a press roller (guide roller G), respectively.

Also similar to the ultrasonic horns 62, 64, and 66, the laser head 72, 74, and 76 fusion bond two or more laminated sheets to each other. That is, the laser head 72 fusion bonds a first diffusion sheet 12 and a first prism sheet 14 to each other, the laser head 74 fusion bonds the first prism sheet 14 and a second prism sheet 16 to each other, and the laser head 76 fusion bonds the second prism sheet 16 and a second diffusion sheet 18 to each other.

The laser heads 72, 74, and 76 are, unlike the laser head 24 in the manufacturing line 11 for optical sheets for display unit in FIG. 7 (First Manufacturing Method), used only in a bonding step, and a punch press apparatus 48 is used in a cutting step. However, basic specifications and peripheral structures of the laser heads 72, 74, and 76 are generally similar to those in the first manufacturing method.

The laser heads 72, 74, and 76 may be set to operate under any condition as far as no bonded portions melt by heat to be split, and a cooling mechanism may be provided to cool connected (fusion bonded) portions of sheets by blowing air or the like after the sheets are connected, as needed.

A punch press apparatus 48 is located downstream of the laser heads 72, 74, and 76. The punch press apparatus 48 has a cutting edge, and the cutting edge is put into the center of the fusion bonded portions to punch out a sheet (the optical sheets for display unit 10 to 60) so that a composite sheet in which only edge portions of all sides or any selected sides thereof are bonded can be obtained.

### (Sixth Manufacturing Method)

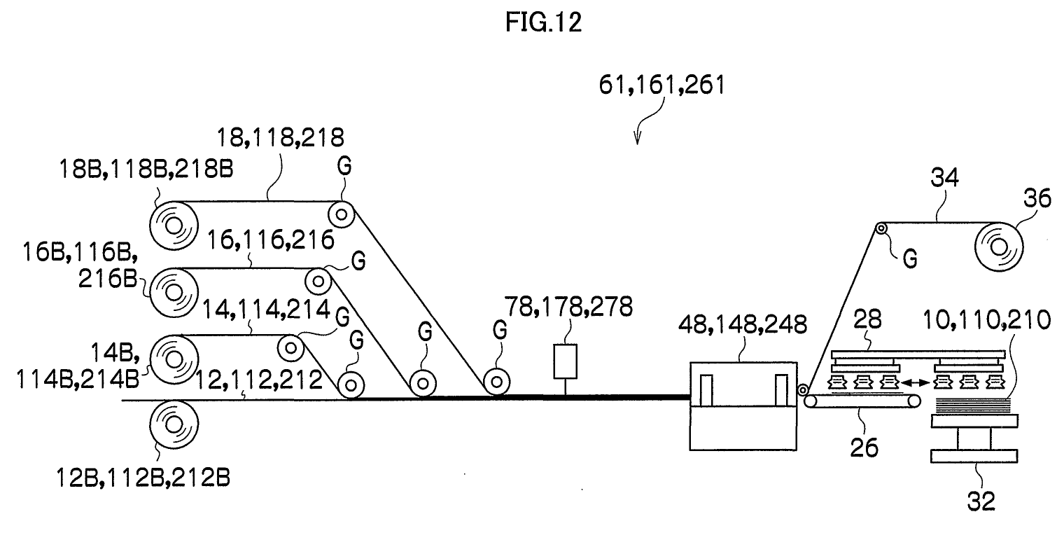

Now, further another manufacturing method for optical sheets for display unit (Sixth Manufacturing Method) will be explained. FIG. 12 is a view showing a configuration of a manufacturing line 61 for optical sheets for display unit which is applied to a sixth manufacturing method. Members in FIG. 12 which are the same or similar to those in the manufacturing line 11 for optical sheets for display unit in FIG. 7 (First Manufacturing Method), those in the manufacturing line 21 for optical sheets for display unit in FIG. 8 (Second Manufacturing Method) and those in the manufacturing line 31 for optical sheets for display unit in FIG. 9 (Third Manufacturing Method) and the like are designated with like reference numerals, and will not be explained in detail below.

The manufacturing line 61 for optical sheets for display unit is provided with one laser head 78 instead of the three laser heads 72, 74, and 76 in the manufacturing line 51 for optical sheets for display unit. The laser head 78 is located downstream of a press roller (guide roller G).

The laser head 78 fusion bonds two or more laminated sheets to each other. That is, the laser head 78 fusion bonds a stack of a first diffusion sheet 12, a first prism sheet 14, a second prism sheet 16, and a second diffusion sheet 18.

The laser head 78 is, unlike the laser head 24 in the manufacturing line 11 for optical sheets for display unit in FIG. 7 (First Manufacturing Method), used only in a bonding step, and a punch press apparatus 48 is used in a cutting step. However, basic specifications and peripheral structures of the laser heads 78 are generally similar to those in the first manufacturing method.

The laser head 78 may be set to operate under any condition as far as no bonded portions melt by heat to be split, and a cooling mechanism may be provided to cool connected (fusion bonded) portions of sheets by blowing air or the like after the sheets are connected, as needed.

A punch press apparatus 48 is located downstream of the laser head 78. The punch press apparatus 48 has a cutting edge, and the cutting edge is put into the center of the fusion bonded portions to punch out a sheet (the optical sheets for display unit 10 to 60) so that a composite sheet in which only edge portions of all sides or any selected sides thereof are bonded can be obtained.

Next, a plane configuration of sheets (optical sheets for display unit 10 to 60) which are punched out from a stack of the first diffusion sheet 12, the first prism sheet 14, second prism sheet 16, and the second diffusion sheet 18 will be explained.

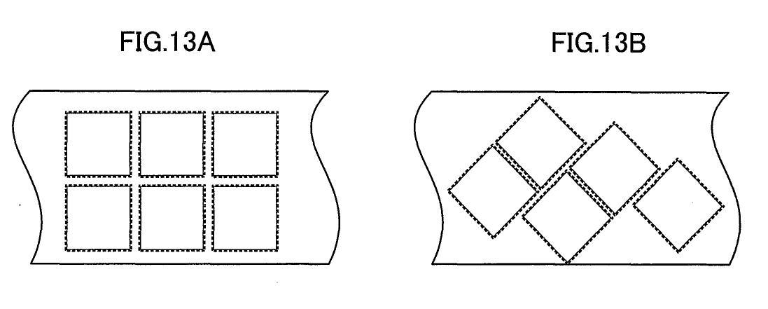

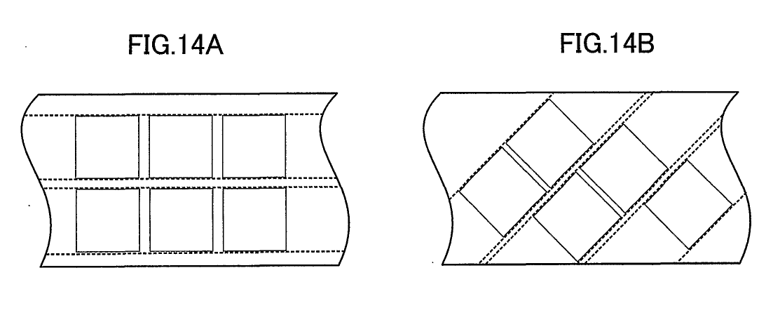

FIGS. 13A and 13B are views illustrating a plane configuration of sheets (optical sheets for display unit 10 to 60) to be punched out of a stack in the first manufacturing method, and FIGS. 14A and 14B are views illustrating a plane configuration of sheets (optical sheets for display unit 10 to 60) to be punched out of a stack in the second to sixth manufacturing methods.

FIG. 13A shows a stack after fusion bonding (bonding step) and punching (cutting step) are completed in a parallel direction relative to the direction in which the stack is transported, and FIG. 13B shows a stack after fusion bonding (bonding step) and punching (cutting step) are completed in an oblique direction relative to the direction in which the stack is transported. In FIGS. 13A and 13B, the spots along the peripheral edges of the sheets to be punched out from the stack are the fusion bonded points.

FIG. 14A shows a stack after fusion bonding or adhering (bonding step) is completed in a parallel direction relative to the direction in which the stack is transported, and FIG. 14B shows a stack after fusion bonding or adhering (bonding step) is completed in an oblique direction relative to the direction in which the stack is transported. In FIGS. 14A and 14B, the spots along the peripheral edges of the sheets to be punched out from the stack are the fusion bonded or adhered points.

As described above, according to the first aspect of the present invention, an optical sheet for display unit can be manufactured in simpler steps at a lower cost and with higher quality compared to conventional methods.

Also, according to the first aspect of the present invention, the following effects 1 and 2 are achieved.

1) Increased Product Value by Achieving Cost Reduction and Low Profile

Since optical sheets need to be rigid to be used in large size of liquid crystal display television, conventionally a substrate for each sheet has a thickness of about twice that of a typical substrate. However, since the optical sheet according to the present invention is a composite of sheets, the optical sheet has a sufficient rigidity without increasing the thickness of each sheet, and also can include sheet layers the thickness of which is reduced.

2) Increased Property by Preventing Reduction of Focusing Effect

In order to prevent (obscure) damages onto lens sheets, some products have a matte-finish back surface. The optical sheet according to the present invention does not need a matte-finish surface, resulting in reducing manufacturing cost, and preventing the reduction of focusing effect due to a matte-finish surface, which increases the property of the optical sheet according to the present invention.

Although exemplary embodiments of a manufacturing method of optical sheet for display unit according to the first aspect of the present invention have been explained, it should be understood that the present invention is not limited to the above embodiments, and various modifications and changes can be added thereto.

For example, in all of the above described embodiments, the first prism sheet 14 and the second prism sheet 16 have prisms which face upward, but the first prism sheet 14 and the second prism sheet 16 may be laminated with prisms facing downward.

The layer structure of an optical sheet for display unit is not limited to those in the above described exemplary embodiments, and protective sheets may be laminated at the top and/or bottom surfaces of the sheet, for example.

Optical sheets for display unit having such configurations operate in the same way as the above described embodiments, and provide similar effects.

### [Second Aspect]

Now, a second aspect of the present invention will be explained with reference to accompanying drawings. First, several exemplary optical sheets for display unit (Seventh to Eleventh embodiments) which are manufactured by a manufacturing method of optical sheet for display unit according to the present invention will be explained, and then several manufacturing methods (Seventh to Twelfth manufacturing methods) of these optical sheets for display unit will be explained.

### Embodiments of Second Aspect

### Seventh Embodiment

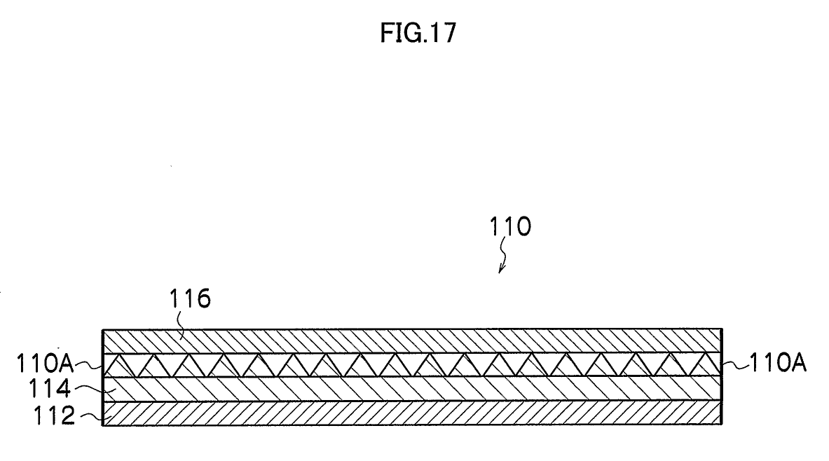

FIG. 17 is a cross sectional view showing an optical sheet for display unit (Seventh Embodiment) manufactured by a manufacturing method of optical sheet for display unit according to the present invention.

An optical sheet for display unit 110 is a module of an optical sheet including, in order from the bottom, a first optical sheet 112, a prism sheet 114, and a second optical sheet 116 which are laminated to each other. The first optical sheet 112 and the second optical sheet 116 may be a reflective polarizing sheet, a diffusion sheet, a transparent optical sheet (e.g. PET, TAC), and the like.

The prism sheet 114 is a lens sheet having convex lenses which are oriented in one axial direction and arranged adjacent to each other generally over an entire surface of the lens sheet. For example, the lenses may have a pitch of 50 μm, a height of concave-convex structure of 25 μm, and an apex angle of a convex portion of 90 degrees (right angle).

The prism sheet 114 is arranged so that the axial direction of the convex lenses (prisms) on the sheet intersects with the sheet at a generally right angle. In other words, in FIG. 17, the axis of the convex lenses on the prism sheet 114 extends in a vertical direction relative to the paper.

The prism sheet 114 may be made of materials similar to those for the first prism sheet 14 and the second prism sheet 16 of the first aspect (First Embodiment), and may be manufactured using methods similar to those for the first prism sheet 14 and the second prism sheet 16 of the first aspect (First Embodiment).

As shown in FIG. 17, at the right and left ends of the optical sheet for display unit 110, bonding sections 110A are formed to connect the layers. The bonding sections 110A are formed by a carbon dioxide gas laser irradiation or the like in a bonding step.

The above described optical sheet for display unit 110 is used to be disposed, for example, between a light source apparatus and liquid crystal cells, thereby forming a liquid crystal display unit as a whole. With the use of the optical sheet for display unit 110, in addition to the various advantages described above (an optical sheet for display unit can be manufactured in simpler steps at a lower cost and with higher quality compared to conventional methods), there is provided another advantage that the liquid crystal display can be quite easily assembled.

### Eighth Embodiment

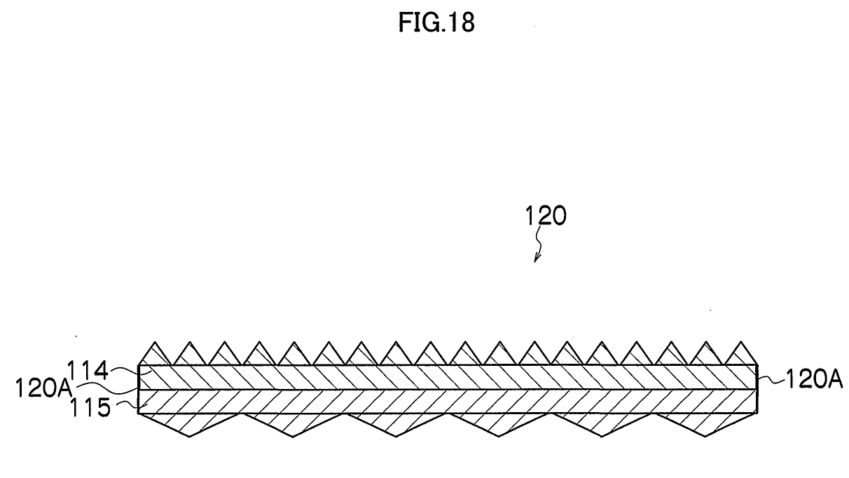

Next, another optical sheet for display unit (Eighth Embodiment) manufactured by a manufacturing method for according to the present invention will be explained. FIG. 18 is a cross sectional view showing a configuration of an optical sheet for display unit 120. Members in FIG. 18 which are the same or similar to those in FIG. 17 (Seventh Embodiment) are designated with like reference numerals, and will not be explained in detail below.

The optical sheet for display unit 120 includes, in order from the bottom, a second prism sheet 115 and a first prism sheet 114 which are laminated to each other. As the previously described optical sheet 110 for display, the optical sheet for display unit 120 includes the second prism sheet 115 because a diffusing property for wide area not only in one (X axis) direction but also in another (Y axis) direction is required. The second prism sheet 115 and the first prism sheet 114 are laminated back to back with the flat surfaces thereof facing to each other.

The first prism sheet 114 and the second prism sheet 115 are arranged so that the axial directions of the convex lenses (prisms) on each sheet intersect with each other at a generally right angle. In other words, in FIG. 18, the axis of the convex lenses on the first prism sheet 114 extends in a vertical direction relative to the paper, and the axis of the convex lenses on the second prism sheet 115 extends in a horizontal direction relative to the paper. However, in FIG. 18, the convex lenses on the second prism sheet 115 are shown in a different direction from the actual direction so that it can be understood that the second prism sheet 115 has a cross section of the convex lens shape.

The above described optical sheet for display unit 120 is used to be disposed, for example, between a light source apparatus and liquid crystal cells, as in Seventh Embodiment, thereby forming a liquid crystal display unit as a whole.

### Ninth Embodiment

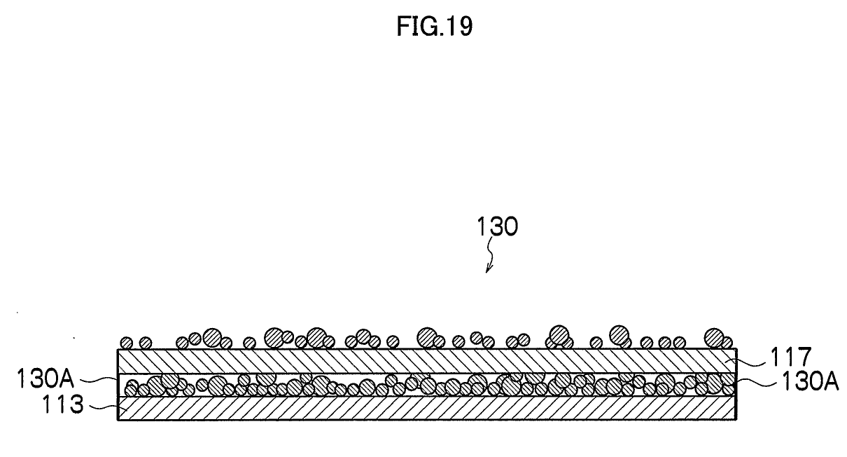

Next, further another optical sheet for display unit (Ninth Embodiment) manufactured by a manufacturing method for according to the present invention will be explained. FIG. 19 is a cross sectional view showing a configuration of an optical sheet for display unit 130.

The optical sheet for display unit 130 includes, in order from the bottom, a first diffusion sheet 113 and second diffusion sheet 117 which are laminated to each other.

The optical sheet for display unit 130 is used when isotropic diffusion is required for a property instead of a directional diffusion as in the above described optical sheet for display unit 110 or the optical sheet for display unit 120.

Each of the first diffusion sheet 113 and the second diffusion sheet 117 is made of a transparent film (substrate) having a surface (one of the surfaces) on which beads are held by a binder, and has a predetermined light diffusing property. The first diffusion sheet 113 and the second diffusion sheet 117 have beads thereon of different diameters (mean particle sizes), and different light diffusing properties from each other.

The transparent film (substrate) used for each of the first diffusion sheet 113 and the second diffusion sheet 117 may be a resin film. The resin film may be made of known materials such as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), biaxially stretched polyethylene terephthalate, polyethylene naphthalate, polyamideimide, polyimide, aromatic polyamide, cellulose acrylate, cellulose triacetate, cellulose acetate propionate, and cellulose diacetate. Among these, polyester, cellulose acrylate, acryl, polycarbonate, and polyolefin are especially preferable.

The first diffusion sheet 113 and the second diffusion sheet 117 should have beads having a diameter of 100 μm or less, and preferably 25 μm or less. For example, the first diffusion sheet 113 and the second diffusion sheet 117 may have beads having a diameter within a predetermined range of 7 to 38 μm, with a mean particle size of 17 μm.

The above described optical sheet for display unit 130 is used to be disposed, for example, between a light source apparatus and liquid crystal cells, as in Seventh Embodiment, thereby forming a liquid crystal display unit as a whole.

### Tenth Embodiment

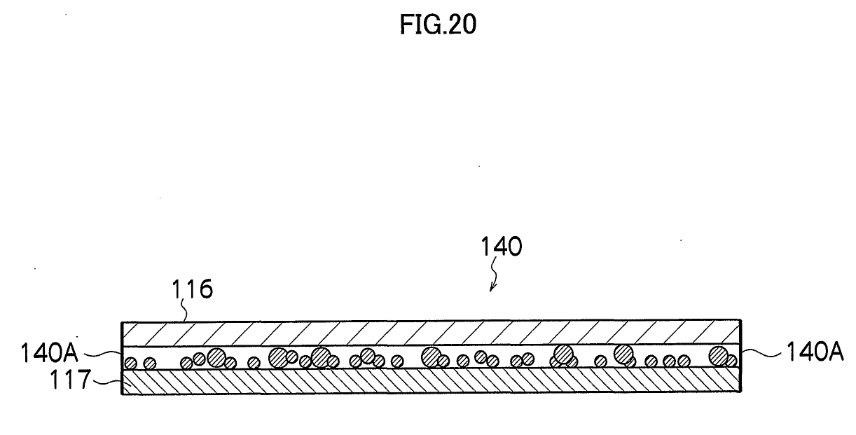

Next, further another optical sheet for display unit (Tenth Embodiment) manufactured by a manufacturing method for according to the present invention will be explained. FIG. 20 is a cross sectional view showing a configuration of an optical sheet for display unit 140.

The optical sheet for display unit 140 includes, in order from the bottom, a diffusion sheet 117 and an optical sheet 116 which are laminated to each other. The optical sheet 116 may be a polarizer.

The above described optical sheet for display unit 140 is used to be disposed, for example, between a light source apparatus and liquid crystal cells, as in Seventh Embodiment, thereby forming a liquid crystal display unit as a whole.

### Eleventh Embodiment

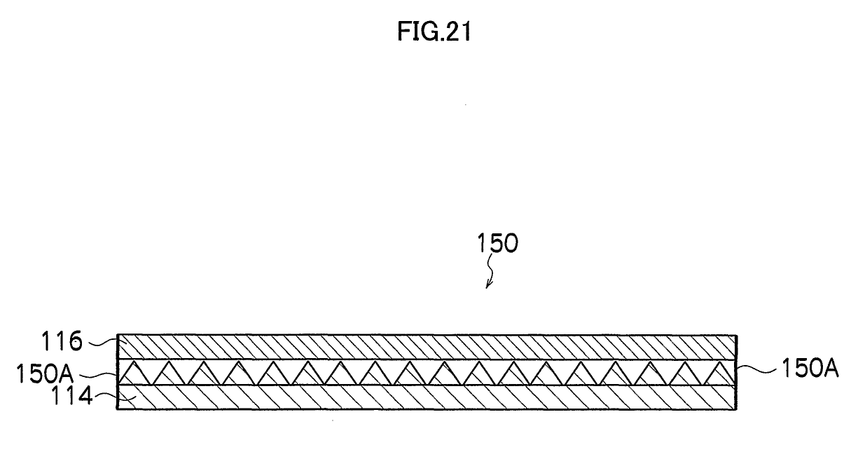

Next, further another optical sheet for display unit (Eleventh Embodiment) manufactured by a manufacturing method for according to the present invention will be explained. FIG. 21 is a cross sectional view showing a configuration of an optical sheet for display unit 150.

The optical sheet for display unit 150 includes, in order from the bottom, a prism sheet 114 and an optical sheet 116 which are laminated to each other. The optical sheet 116 may be a polarizer.

The above described optical sheet for display unit 150 is used to be disposed, for example, between a light source apparatus and liquid crystal cells, as in Seventh Embodiment, thereby forming a liquid crystal display unit as a whole.

### [Manufacturing Method of Second Aspect]

Now, several manufacturing methods for optical sheets for display unit (Seventh to Twelfth Manufacturing Methods) will be explained. These manufacturing methods may be commonly used for the optical sheets for display unit 110 to 150, but for simplicity of explanation, only embodiments in which the manufacturing methods are applied to an optical sheet for display unit including four laminated layers will be explained. Such an optical sheet for display unit including four laminated layers may be, for example, the optical sheet for display unit 110 of Seventh Embodiment to which a protective sheet 118 is added at the (top) surface thereof.

### (Seventh Manufacturing Method)

FIG. 7 is a view showing a configuration of a manufacturing line 111 for an optical sheet for display unit which is applied to a seventh manufacturing method (FIG. 7 is used to explain the manufacturing line 111 for optical sheets for display unit because the manufacturing line 111 is generally configured in the same way as the manufacturing line 11 for optical sheets for display unit of the first aspect). Rolls 112B, 114B, 116B, and 118B at the left end of FIG. 7 wind up the first optical sheet 112, the prism sheet 114, the second optical sheet 116, and the above described protective sheet 118 shown in FIG. 17, respectively.

Each of the rolls 112B, 114B, 116B, and 118B are supported by a rotary shaft of supply means (not shown), and the first optical sheet 112, the prism sheet 114, the second optical sheet 116, and the protective sheet 118 can be supplied from the rolls 112B, 114B, 116B, and 118B respectively at a generally same speed.

After being supplied, the first optical sheet 112, the prism sheet 114, the second optical sheet 116, and the protective sheet 118 are supported by a guide rollers G respectively, to be laminated to each other upstream of a laser head 124 which will be explained below (laminating step).

The laser head 124 is included in a laser beam generating apparatus which may be configured in the same way as the laser head 24 of the first aspect, and a manufacturing step for manufacturing optical sheets for display unit using the laser beam generating apparatus may be done in the same way as in the first aspect.

According to this manufacturing method of optical sheet for display unit (Seventh Manufacturing Method), three advantages (that is, an effect on reducing damage and failure, an effect on reducing the number of assembly steps, and an effect on reducing of protective sheets) are achieved as in the first aspect.

For example, as for the effect on reducing of protective sheets, one protective sheet for the prism sheet 114 can be saved in the optical sheet for display unit 150 of the eleventh embodiment (see FIG. 21), two protective sheets for the prism sheet 114 can be saved in the optical sheet for display unit 110 of the seventh embodiment (see FIG. 17), and two protective sheets for the prism sheets 114 and 115 can be saved in the optical sheet for display unit 120 of the eighth embodiment (see FIG. 18).

### (Eighth Manufacturing Method)

Next, further another manufacturing method of optical sheet for display unit (Eighth Manufacturing Method) will be explained. FIG. 8 is a view showing a configuration of a manufacturing line 121 for an optical sheet for display unit which is applied to a eighth manufacturing method (FIG. 8 is used to explain the manufacturing line 121 for optical sheets for display unit because the manufacturing line 121 is generally configured in the same way as the manufacturing line 21 for optical sheets for display unit of the first aspect). Members in the manufacturing line 121 for optical sheets for display unit which are the same or similar to those in the manufacturing line 111 for optical sheets for display unit (Seventh Embodiment) are designated with like reference numerals, and will not be explained in detail below.

The optical sheet for display unit manufacturing line 121 is provided with dispensers 142, 144, and 146 and punch press apparatus 148 instead of the laser head 124 in the manufacturing line 111 for optical sheets for display unit.

The dispensers 142, 144, and 146 are suppliers for separately discharging an adhesive from each distal end thereof. The dispenser 142 supplies an adhesive to a front surface of a first optical sheet 112 to adhere the first optical sheet 112 and a prism sheet 114 together, the dispenser 144 supplies an adhesive to a front surface of the prism sheet 114 to adhere the prism sheet 114 and a second optical sheet 116 together, and the dispenser 146 supplies an adhesive to a front surface of the second prism sheet 116 to adhere the second prism sheet 116 and a protective sheet 18 together.

In the manufacturing line 121 for optical sheets for display unit having the above described configuration, optical sheets for display unit can be manufactured as in the first aspect.

### (Ninth Manufacturing Method)

Next, further another manufacturing method of optical sheet for display unit (Ninth Manufacturing Method) will be explained. FIG. 9 is a view showing a configuration of a manufacturing line 131 for an optical sheet for display unit which is applied to a ninth manufacturing method (FIG. 9 is used to explain the manufacturing line 131 for optical sheets for display unit because the manufacturing line 131 is generally configured in the same way as the manufacturing line 31 for optical sheets for display unit of the first aspect). Members in the manufacturing line 131 for optical sheets for display unit which are the same or similar to those in the manufacturing line 111 for optical sheets for display unit (Seventh Embodiment) and those in the manufacturing line 121 for optical sheets for display unit (Eighth Embodiment) are designated with like reference numerals, and will not be explained in detail below.

The optical sheet for display unit manufacturing line 131 is provided with tape dispensing apparatus 152, 154, and 156 instead of the dispenser 142, 144, 146 in the manufacturing line 121 for optical sheets for display unit. The tape dispensing apparatuses 152, 154, and 156 separately supply two-sided tapes from each distal end thereof.

The tape dispensing apparatus 152 supplies a two-sided tape to a front surface of a first optical sheet 112 to adhere the first optical sheet 112 and a prism sheet 114 together, the tape dispensing apparatus 154 supplies a two-sided tape to a front surface of the prism sheet 114 to adhere the prism sheet 114 and a second optical sheet 116 together, and the tape dispensing apparatus 156 supplies a two-sided tape to a front surface of the second optical sheet 116 to adhere the second optical sheet 116 and a protective sheet 118 together.

The other configuration of the manufacturing line 131 for optical sheets for display unit is similar to those in the manufacturing line 31 for optical sheets for display unit of the first aspect, and so will not be explained in detail below.

In the manufacturing line 131 for optical sheets for display unit having the above described configuration, optical sheets for display unit can be manufactured as in the first aspect.

### (Tenth Manufacturing Method)

Next, further another manufacturing method of optical sheet for display unit (Tenth Manufacturing Method) will be explained. FIG. 10 is a view showing a configuration of a manufacturing line 141 for an optical sheet for display unit which is applied to a tenth manufacturing method (FIG. 10 is used to explain the manufacturing line 141 for optical sheets for display unit because the manufacturing line 141 is generally configured in the same way as the manufacturing line 41 for optical sheets for display unit of the first aspect). Members in the manufacturing line 141 for optical sheets for display unit which are the same or similar to those in the manufacturing line 111 for optical sheets for display unit of FIG. 7 (Seventh Manufacturing Method), those in the manufacturing line 121 for optical sheets for display unit of FIG. 8 (Eighth Manufacturing Method), and those in the manufacturing line 131 for optical sheets for display unit of FIG. 9 (Ninth Manufacturing Method) are designated with like reference numerals, and will not be explained in detail below.

The optical sheet for display unit manufacturing line 141 is provided with ultrasonic horns 162, 164, and 166 instead of the dispensers 142, 144, and 146 in the manufacturing line 121 for optical sheets for display unit. Each of the ultrasonic horns 162, 164, and 166 is located downstream of a press roller (guide roller G).

The ultrasonic horns 162, 164, and 166 fusion bond two or more laminated sheets to each other. That is, the ultrasonic horn 162 fusion bonds a first optical sheet 112 and a prism sheet 114 to each other, the ultrasonic horn 164 fusion bonds the prism sheet 114 and a second optical sheet 116 to each other, and the ultrasonic horn 166 fusion bonds the second optical sheet 116 and a protective sheet 118 to each other.

The ultrasonic horns 162, 164, and 166 (ultrasonic bonding apparatuses) may be configured in the same way as the ultrasonic horns 62, 64, and 66 of the first aspect.

A punch press apparatus 148 also may be configured in the same way as the punch press apparatus 48 of the first aspect.

### (Eleventh Manufacturing Method)

Next, further another manufacturing method of optical sheet for display unit (Eleventh Manufacturing Method) will be explained. FIG. 11 is a view showing a configuration of a manufacturing line 151 for an optical sheet for display unit which is applied to a eleventh manufacturing method (FIG. 11 is used to explain the manufacturing line 151 for optical sheets for display unit because the manufacturing line 151 is generally configured in the same way as the manufacturing line 51 for optical sheets for display unit of the first aspect). Members in the manufacturing line 151 for optical sheets for display unit which are the same or similar to those in the manufacturing line 111 for optical sheets for display unit of FIG. 7 (Seventh Manufacturing Method), those in the manufacturing line 121 for optical sheets for display unit of FIG. 8 (Eighth Manufacturing Method), those in the manufacturing line 131 for optical sheets for display unit of FIG. 9 (Ninth Manufacturing Method) and the like are designated with like reference numerals, and will not be explained in detail below.

The optical sheet for display unit manufacturing line 151 is provided with laser heads 172, 174, and 176 instead of the ultrasonic horns 162, 164, and 166 in the manufacturing line 141 for optical sheets for display unit. The laser heads 172, 174, and 176 are located downstream of a press roller (guide roller G) in the same way as the ultrasonic horns 162, 164, and 166 respectively.

The laser heads 172, 174, and 176, similar to ultrasonic horns 162, 164, and 166, fusion bond two or more laminated sheets to each other. That is, the laser head 172 fusion bonds a first optical sheet 112 and a prism sheet 114 together, and the laser head 174 fusion bonds the prism sheet 114 and a second optical sheet 116 together, and the laser head 176 fusion bonds the second optical sheet 116 and a protective sheet 118 together.

The other configuration of the manufacturing line 151 for optical sheets for display unit is similar to those in the manufacturing line 51 for optical sheets for display unit of the first aspect, and so will not be explained in detail below.

In the manufacturing line 151 for optical sheets for display unit having the above described configuration, optical sheets for display unit can be manufactured as in the first aspect.

### (Twelfth Manufacturing Method)

Next, further another manufacturing method of optical sheet for display unit (Twelfth Manufacturing Method) will be explained. FIG. 12 is a view showing a configuration of a manufacturing line 161 for an optical sheet for display unit which is applied to a twelfth manufacturing method (FIG. 12 is used to explain the manufacturing line 161 for optical sheets for display unit because the manufacturing line 161 is generally configured in the same way as the manufacturing line 61 for optical sheets for display unit of the first aspect). Members in the manufacturing line 161 for optical sheets for display unit which are the same or similar to those in the manufacturing line 111 for optical sheets for display unit of FIG. 7 (Seventh Manufacturing Method), the manufacturing line 121 for optical sheets for display unit of FIG. 8 (Eighth Manufacturing Method), those in the manufacturing line 131 for optical sheets for display unit of FIG. 9 (Ninth Manufacturing Method) and the like are designated with like reference numerals, and will not be explained in detail below.

The manufacturing line 161 for optical sheets for display unit is provided with one laser head 178 instead of the three laser heads 172, 174, and 176 in the manufacturing line 151 for optical sheets for display unit. The laser head 178 is located downstream of a roller (guide roller G).

The laser head 178 fusion bond two or more laminated sheets to each other. That is, the laser head 178 fusion bonds a stack of a first optical sheet 112, a prism sheet 114, a second optical sheet 116, and a protective sheet 118 together.

The configurations of the laser head 178 and a punch press apparatus 148 are similar to those in the laser head 78 and the punch press apparatus 48 of the first aspect, and so will not be explained in detail below.

In the above described second aspects, plane configurations of sheets (optical sheets for display unit 110 to 130) which are punched out from a stack of the first optical sheet 112, the prism sheet 114, the second optical sheet 116, and the protective sheet 118 are similar to those of the first aspect (see FIGS. 13A and 13B, and FIGS. 14A and 14B).

As described above, according to the second aspect of the present invention, an optical sheet for display unit can be manufactured in simpler steps at a lower cost and with higher quality compared to conventional methods.

Furthermore, according to the second aspect of the present invention, two advantages (that is, increased product value by achieving cost reduction and low profile, and increased property by preventing reduction of focusing effect) are achieved as in the first aspect.

Although exemplary embodiments of a manufacturing method of optical sheet for display unit according to the second aspect of the present invention have been explained, it should be understood that the present invention is not limited to the above embodiments, and various modifications and changes can be added thereto.

The layer structure of an optical sheet for display unit is not limited to those in the above described exemplary embodiments, and protective sheets may be laminated at the top and/or bottom surfaces of the sheet, for example.

Optical sheets for display unit having such configurations operate in the same way as the above described embodiments, and provide similar effects.

### [Third Aspect]

Now, a third aspect of the present invention will be explained with reference to accompanying drawings. First, several exemplary optical sheets for display unit (Twelfth to Fourteenth embodiments) which are manufactured by a manufacturing method of optical sheet for display unit according to the present invention will be explained, and then several manufacturing methods (Thirteenth to Eighteenth manufacturing methods) of these optical sheets for display unit will be explained.

### Embodiments of Third Aspect

### Twelfth Embodiment

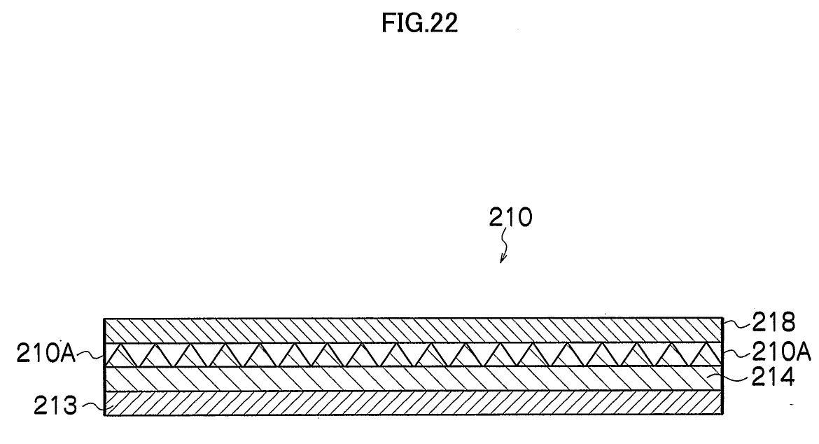

FIG. 22 is a cross sectional view showing an optical sheet for display unit (Twelfth Embodiment) manufactured by a manufacturing method of optical sheet for display unit according to the present invention.

An optical sheet for display unit 210 is a module of an optical sheet including, in order from the bottom, a first optical sheet 213, a prism sheet 214, and a second optical sheet 218 which are laminated to each other. The first optical sheet 213 and the second optical sheet 218 may be a reflective polarizing sheet, a diffusion sheet, a transparent optical sheet (e.g. PET, TAC), and the like.

The prism sheet 214 is a lens sheet having convex lenses of a generally similar shape which are oriented in a matrix and arranged adjacent to each other generally over an entire surface thereof. Each of the convex lenses (unit lens) may have a conical, frustum, partly spherical (e.g. semi-spherical) cross section. The convex lenses may be arranged in a matrix of a lattice-shape (grid) pattern, a twilled pattern, and the like. For example, when convex lenses having a hexagonal pyramid cross section are arranged in a matrix of a twilled pattern on a film, a lens sheet can be obtained which has convex lenses of a hexagonal pyramid shape fully arranged thereto without any flat spaces between the lenses.

Specifically, the prism sheet 214 may have convex lenses of a quadrangular pyramid shape thereon which are arranged with a pitch of 50 μm in the X and Y directions, and have a height of concave-convex structure of 25 μm, and an apex angle of a convex portion of 90 degrees (right angle).

The prism sheet 214 may be made of materials similar to those for the first prism sheet 14 and the second prism sheet 16 of the first aspect (First Embodiment) and the prism sheet 114 of the second aspect, and may be manufactured using methods similar to those for the first prism sheet 14 and the second prism sheet 16 of the first aspect (First Embodiment) and the prism sheet 114 of the second aspect.

As shown in FIG. 22, at the right and left ends of the optical sheet for display unit 210, bonding sections 210A are formed to connect the layers. The bonding sections 210A are formed by a carbon dioxide gas laser irradiation or the like in a bonding step.

The optical sheet for display unit 210 is used to be disposed, for example, between a light source apparatus and liquid crystal cells, thereby forming a liquid crystal display unit as a whole. With the use of the optical sheet for display unit 210, in addition to the various advantages described above (an optical sheet for display unit can be manufactured in simpler steps at a lower cost and with higher quality compared to conventional methods), there is provided another advantage that the liquid crystal display unit can be quite easily assembled.

### Thirteenth Embodiment

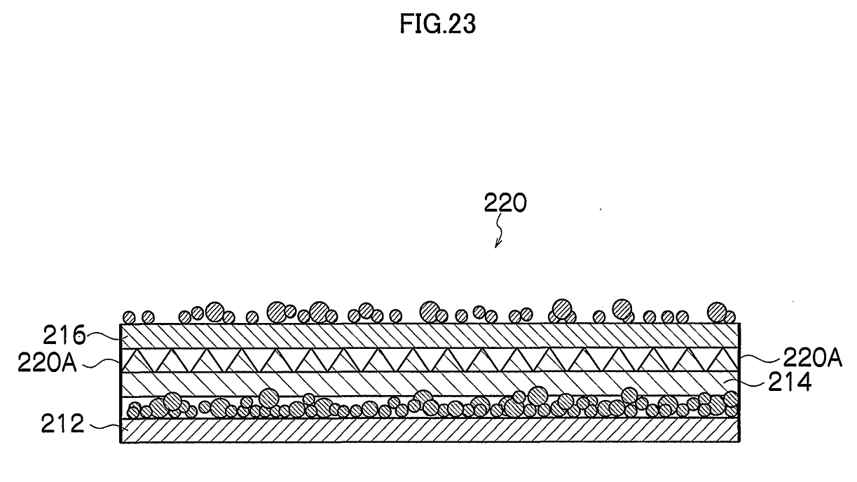

Next, further another optical sheet for display unit (Thirteenth Embodiment) manufactured by a manufacturing method for according to the present invention will be explained. FIG. 23 is a cross sectional view showing a configuration of an optical sheet for display unit 220. Members in FIG. 23 which are the same or similar to those in FIG. 22 (Twelfth Embodiment) are designated with like reference numerals, and will not be explained in detail below.

An optical sheet for display unit 220 includes, in order from the bottom, a diffusion sheet 212, a prism sheet 214, and a second diffusion sheet 216 which are laminated to each other.

Each of the first diffusion sheet 212 and the second diffusion sheet 216 is made of a transparent film (substrate) having a surface (one of the surfaces) on which beads are held by a binder, and has a predetermined light diffusing property. The first diffusion sheet 212 and the second diffusion sheet 216 have beads thereon of different diameters (mean particle sizes), and different light diffusing properties from each other.

The transparent film (substrate) used for each of the first diffusion sheet 212 and the second diffusion sheet 216 may be a resin film. The resin films may be made of materials similar to those for the first diffusion sheet 13 and second diffusion sheet 17 of the second aspect.

The first diffusion sheet 212 and the second diffusion sheet 216 should have beads having a diameter of 100 μm or less, and preferably 25 μm or less. For example, the first diffusion sheet 212 and the second diffusion sheet 216 may have beads having a diameter within a predetermined range of 7 to 38 μm, with a mean particle size of 17 μm.

The above described optical sheet for display unit 220 is used to be disposed, for example, between a light source apparatus and liquid crystal cells, as in Twelfth Embodiment, thereby forming a liquid crystal display unit as a whole.

### Fourteenth Embodiment

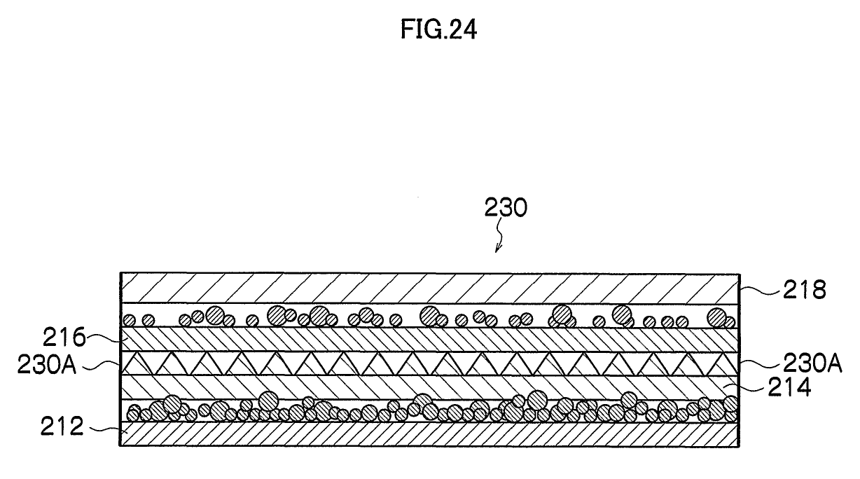

Next, further another optical sheet for display unit (Fourteenth Embodiment) manufactured by a manufacturing method for according to the present invention will be explained. FIG. 24 is a cross sectional view showing a configuration of an optical sheet for display unit 230. Members in FIG. 24 which are the same or similar to those in FIG. 22 (Twelfth Embodiment) and FIG. 23 (Thirteenth Embodiment) are designated with like reference numerals, and will not be explained in detail below.

An optical sheet for display unit 230 includes, in order from the bottom, a first diffusion sheet 212, a prism sheet 214, a second diffusion sheet 216, and an optical sheet 218 which are laminated to each other.

The optical sheet for display unit 230 is configured to have the optical sheet 218 laminated to a structure similar to that of the optical sheet for display unit 220 (Thirteenth Embodiment). The optical sheet 218 may be a reflective polarizing sheet, a diffusion sheet, a transparent optical sheet (e.g. PET, TAC), and the like.

The above described optical sheet for display unit 230 is used to be disposed, for example, between a light source apparatus and liquid crystal cells, as in Twelfth Embodiment, thereby forming a liquid crystal display unit as a whole.

### [Manufacturing Method of Third Aspect]

Now, several manufacturing methods for optical sheets for display unit (Thirteenth to Eighteenth Manufacturing Methods) will be explained. These manufacturing methods may be commonly used for the optical sheets for display unit 210 to 230, but for simplicity of explanation, only embodiments in which the manufacturing methods are applied to an optical sheet for display unit including four laminated layers (Fourteenth Embodiment) will be explained.

### (Thirteenth Manufacturing Method)

FIG. 7 is a view showing a configuration of a manufacturing line 211 for an optical sheet for display unit which is applied to a thirteenth manufacturing method (FIG. 7 is used to explain the manufacturing line 211 for optical sheets for display unit because the manufacturing line 211 is generally configured in the same way as the manufacturing line 11 for optical sheets for display unit of the first aspect). Rolls 212B, 214B, 216B, and 218B at the left end of FIG. 7 wind up a first diffusion sheet 212, a prism sheet 214, a second diffusion sheet 216, and a optical sheet 218 shown in FIG. 24, respectively.

Each of the rolls 212B, 214B, 216B, and 218B are supported by a rotary shaft of supply means (not shown), and the first diffusion sheet 212, the prism sheet 214, the second diffusion sheet 216, and the optical sheet 218 can be supplied from the rolls 212B, 214B, 216B, and 218B respectively at a generally same speed.

After being supplied, the first diffusion sheet 212, the prism sheet 214, the second diffusion sheet 216, and the optical sheet 218 are supported by a guide rollers G respectively, to be laminated to each other upstream of a laser head 224 which will be explained below (laminating step).

The laser head 224 is included in a laser beam generating apparatus which may be configured in the same way as the laser head 24 of the first aspect and the laser head 124 of the second aspect, and a manufacturing step for manufacturing optical sheets for display unit using the laser beam generating apparatus may be done in the same way as in the first aspect.

According to the manufacturing method of optical sheet for display unit (Thirteenth Manufacturing Method), one advantage (effect on reducing damage and failure) is achieved as in the first and second aspects.

As for the advantage of effect on reducing the number of assembly steps, for example, in assembling of a liquid crystal display, with use of the optical sheet for display unit 230 of the fourteenth embodiment (see FIG. 23), only one step for installing the optical sheet for display unit 230 in is required, while with use of conventional article, six steps are required: installing of a first diffusion sheet; peeling of a back protective sheet of a lens sheet; peeling of a front protective sheet of the lens sheet; installing of the lens sheet; installing of a second diffusion sheet; and install of an optical sheet. Thus, according to the thirteenth manufacturing method, the number of assembly steps can be significantly reduced, which reduces final product cost.

Furthermore, the advantage of effect on reducing of protective sheets can be achieved as in the first and second aspects. Specifically, two protective sheets for the prism sheet 214 can be saved in the optical sheet for display unit 210 of the twelfth embodiment (see FIG. 22), two protective sheets for the prism sheet 214 can be saved in the optical sheet for display unit 220 of the thirteenth embodiment (see FIG. 23), and two protective sheets for the prism sheet 214 can be saved in the optical sheet for display unit 230 of the fourteenth embodiment (see FIG. 24).

### (Fourteenth Manufacturing Method)

Next, further another manufacturing method of optical sheet for display unit (Fourteenth Manufacturing Method) will be explained. FIG. 8 is a view showing a configuration of a manufacturing line 221 for an optical sheet for display unit which is applied to a fourteenth manufacturing method (FIG. 8 is used to explain the manufacturing line 221 for optical sheets for display unit because the manufacturing line 221 is generally configured in the same way as the manufacturing line 21 for optical sheets for display unit of the first aspect). Members in the manufacturing line 221 for optical sheets for display unit which are the same or similar to those in the manufacturing line 211 for optical sheets for display unit of FIG. 7 (Thirteenth Manufacturing Method) are designated with like reference numerals, and will not be explained in detail below.

The optical sheet for display unit manufacturing line 221 is provided with dispensers 242, 244, and 246 and a punch press apparatus 248 instead of the laser head 224 in the manufacturing line 211 for optical sheets for display unit.

The dispensers 242, 244, and 246 are suppliers for separately discharging an adhesive from each distal end thereof. The dispenser 242 supplies an adhesive to a front surface of a first diffusion sheet 212 to adhere the first diffusion sheet 212 and a prism sheet 214 together, the dispenser 244 supplies an adhesive to a front surface of the prism sheet 214 to adhere the prism sheet 214 and a second diffusion sheet 216 together, and the dispenser 246 supplies an adhesive to a front surface of the second diffusion sheet 216 to adhere the second diffusion sheet 216 and an optical sheet 218 together.

In the manufacturing line 221 for optical sheets for display unit having the above described configuration, optical sheets for display unit can be manufactured as in the first and second aspects.

### (Fifteenth Manufacturing Method)

Next, further another manufacturing method of optical sheet for display unit (Fifteenth Manufacturing Method) will be explained. FIG. 9 is a view showing a configuration of a manufacturing line 231 for an optical sheet for display unit which is applied to a fifteenth manufacturing method (FIG. 9 is used to explain the manufacturing line 231 for optical sheets for display unit because the manufacturing line 231 is generally configured in the same way as the manufacturing line 31 for optical sheets for display unit of the first aspect). Members in the manufacturing line 231 for optical sheets for display unit which are the same or similar to those in the manufacturing line 211 for optical sheets for display unit of FIG. 7 (Thirteenth Manufacturing Method) and the manufacturing line 221 for optical sheets for display unit of FIG. 8 (Fourteenth Manufacturing Method) are designated with like reference numerals, and will not be explained in detail below.

The optical sheet for display unit manufacturing line 231 is provided with tape dispensing apparatus 252, 254, and 256 instead of the dispensers 242, 244, and 246 in the manufacturing line 221 for optical sheets for display unit. The tape dispensing apparatuses 252, 254, and 256 separately supply a two-sided tape from each distal end thereof.

The tape dispensing apparatus 252 supplies a two-sided tape to a front surface of a first diffusion sheet 212 to adhere the first diffusion sheet 212 and a prism sheet 214 together, the tape dispensing apparatus 254 supplies a two-sided tape to a front surface of the prism sheet 214 to adhere the prism sheet 214 and a second diffusion sheet 216 together, and the tape dispensing apparatus 256 supplies a two-sided tape to a front surface of the second diffusion sheet 216 to adhere the second diffusion sheet 216 and an optical sheet 218 together.

The other configuration of the manufacturing line 231 for optical sheets for display unit is similar to those in the manufacturing line 31 for optical sheets for display unit of the first aspect and the manufacturing line 131 for optical sheets for display unit of the second aspect, and so will not be explained in detail below.

In the manufacturing line 231 for optical sheets for display unit having the above described configuration, optical sheets for display unit can be manufactured as in the first and second aspects.

### (Sixteenth Manufacturing Method)

Next, further another manufacturing method of optical sheet for display unit (Sixteenth Manufacturing Method) will be explained. FIG. 10 is a view showing a configuration of a manufacturing line 241 for an optical sheet for display unit which is applied to a sixteenth manufacturing method (FIG. 10 is used to explain the manufacturing line 241 for optical sheets for display unit because the manufacturing line 241 is generally configured in the same way as the manufacturing line 41 for optical sheets for display unit of the first aspect). Members in the manufacturing line 241 for optical sheets for display unit which are the same or similar to those in the manufacturing line 211 for optical sheets for display unit of FIG. 7 (Thirteenth Manufacturing Method), the manufacturing line 221 for optical sheets for display unit of FIG. 8 (Fourteenth Manufacturing Method) and the manufacturing line 231 for optical sheets for display unit of FIG. 9 (Fifteenth Manufacturing Method) are designated with like reference numerals, and will not be explained in detail below.

The optical sheet for display unit manufacturing line 241 is provided with ultrasonic horns 262, 264, and 266 instead of the dispensers 242, 244, and 246 in the manufacturing line 221 for optical sheets for display unit. The ultrasonic horns 262, 264, and 266 are located downstream of a press roller (guide roller G), respectively.

The ultrasonic horns 262, 264, and 266 fusion bond two or more laminated sheets to each other. That is, the ultrasonic horn 262 fusion bonds a first diffusion sheet 212 and a prism sheet 214 together, and the ultrasonic horn 264 fusion bonds the prism sheet 214 and a second diffusion sheet 216 together, and the ultrasonic horn 266 fusion bonds the second diffusion sheet 216 and an optical sheet 218 together.

The ultrasonic horns 262, 264, and 266 (ultrasonic bonding apparatuses) may be configured in the same way as the ultrasonic horns 62, 64, and 66 of the first aspect, and the ultrasonic horns 162, 164, and 166 of the second aspect.

A punch press apparatus 248 also may be configured in the same way as the punch press apparatus 48 of the first aspect and the punch press apparatus 148 of the second aspect.

### (Seventeenth Manufacturing Method)

Next, further another manufacturing method of optical sheet for display unit (Seventeenth Manufacturing Method) will be explained. FIG. 11 is a view showing a configuration of a manufacturing line 251 for an optical sheet for display unit which is applied to a seventeenth manufacturing method (FIG. 11 is used to explain the manufacturing line 251 for optical sheets for display unit because the manufacturing line 251 is generally configured in the same way as the manufacturing line 51 for optical sheets for display unit of the first aspect). Members in the manufacturing line 251 for optical sheets for display unit which are the same or similar to those in the manufacturing line 211 for optical sheets for display unit of FIG. 7 (Thirteenth Manufacturing Method), the manufacturing line 221 for optical sheets for display unit of FIG. 8 (Fourteenth Manufacturing Method) and the manufacturing line 231 for optical sheets for display unit of FIG. 9 (Fifteenth Manufacturing Method) and the like are designated with like reference numerals, and will not be explained in detail below.

The optical sheet for display unit manufacturing line 251 is provided with laser heads 272, 274, and 276 instead of the ultrasonic horns 262, 264, and 266 in the optical sheet for display unit manufacturing line 241. The laser heads 272, 274, and 276 are located downstream of a press roller (guide roller G) in the same way as the ultrasonic horns 262, 264, and 266, respectively.

The laser heads 272, 274, and 276, similar to ultrasonic horns 262, 264, and 266, fusion bond two or more laminated sheets to each other. That is, the laser head 272 fusion bonds a first diffusion sheet 212 and a prism sheet 214 together, and the laser head 274 fusion bonds the prism sheet 214 and a second diffusion sheet 216 together, and the laser head 276 fusion bonds the second diffusion sheet 216 and an optical sheet 218 together.

The other configuration of the manufacturing line 251 for optical sheets for display unit is similar to those in the manufacturing line 51 for optical sheets for display unit of the first aspect and the manufacturing line 151 for optical sheets for display unit of the second aspect, and so will not be explained in detail below.

In the manufacturing line 251 for optical sheets for display unit having the above described configuration, optical sheets for display unit can be manufactured as in the first aspect.

### (Eighteenth Manufacturing Method)

Next, further another manufacturing method of optical sheet for display unit (Eighteenth Manufacturing Method) will be explained. FIG. 12 is a view showing a configuration of a manufacturing line 261 for an optical sheet for display unit which is applied to a eighteenth manufacturing method (FIG. 12 is used to explain the manufacturing line 261 for optical sheets for display unit because the manufacturing line 261 is generally configured in the same way as the manufacturing line 61 for optical sheets for display unit of the first aspect). Members in the manufacturing line 261 for optical sheets for display unit which are the same or similar to those in the manufacturing line 211 for optical sheets for display unit of FIG. 7 (Thirteenth Manufacturing Method), the manufacturing line 221 for optical sheets for display unit of FIG. 8 (Fourteenth Manufacturing Method) and the manufacturing line 231 for optical sheets for display unit of FIG. 9 (Fifteenth Manufacturing Method) and the like are designated with like reference numerals, and will not be explained in detail below.

The manufacturing line 261 for optical sheets for display unit is provided with one laser head 278 instead of the three laser heads 272, 274, 276 in the manufacturing line 251 for optical sheets for display unit. The laser head 278 is located downstream of a roller (guide roller G).

The laser head 278 fusion bond two or more laminated sheets to each other. That is, the laser head 278 fusion bonds a stack of a first diffusion sheet 212, a prism sheet 214, a second diffusion sheet 216, and an optical sheet 218 together.

The configurations of the laser head 278 and a punch press apparatus 248 are similar to those in the laser heads and the punch press apparatuses of the first and second aspects, and so will not be explained in detail below.

In the above described third aspects, plane configurations of sheets (optical sheets for display unit 210 to 230) which are punched out from a stack of the first diffusion sheet 212, the prism sheet 214, the second diffusion sheet 216, and the optical sheet 218 are similar to those of the first and second aspects (see FIGS. 13A and 13B, and FIGS. 14A and 14B).

According to the third aspect of the present invention, an optical sheet for display unit can be manufactured in simpler steps at a lower cost and with higher quality compared to conventional methods.

Furthermore, according to the third aspect of the present invention, two advantages (that is, increased product value by achieving cost reduction and low profile, and increased property by preventing reduction of focusing effect) are achieved as in the second aspect.

Although exemplary embodiments of a manufacturing method of optical sheet for display unit according to the third aspect of the present invention have been explained, it should be understood that the present invention is not limited to the above embodiments, and various modifications and changes can be added thereto.

The layer structure of an optical sheet for display unit is not limited to those in the above described exemplary embodiments, and protective sheets may be laminated at the top and/or bottom surfaces of the sheet, for example.

Optical sheets for display unit having such configurations operate in the same way as the above described embodiments, and provide similar effects.

### EXAMPLE

Now, examples of the first embodiment according to the present invention will be explained below.

### [Fabrication of Prism Sheet]

A prism sheet for a first prism sheet 14 and a second prism sheet 16 was fabricated as follows. This prism sheet is used both as the first prism sheet 14 and as the second prism sheet 16.

### Preparation of Resin Solution

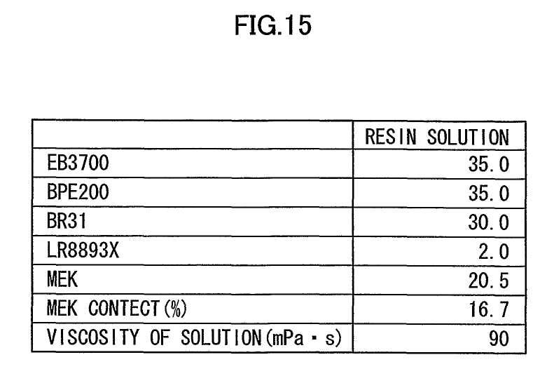

Compounds in FIG. 15 were mixed at the listed weight ratio, and the mixture was heated to 50° C. with stirring until all the compounds was dissolved to prepare a resin solution. The names and ingredients of the compounds are as follows:
EB3700: Ebecryl 3700, Dicel UC Co., Ltd., bisphenol A epoxy acrylate, (Viscosity: 2200 mPa·s/65° C.)
BPE200: NK ester BPE-200, Shin-Nakamura Chemical Co., Ltd., ethylene oxide added bisphenol A ester methacrylate (Viscosity: 590 mPa·s/25° C.)
BR-31: New Frontier BR-31, Dai-ichi Kogyo Seiyaku Co., Ltd., tribromophenoxy ethyl acrylate (solid at room temperature, melting point: 50° C. or more)
LR8893X: Lucirin LR8893X, a free radical initiator from BASF Corp., ethyl-2,4,6-trimethyl-benzoyl ethoxyphenyl osphine oxide
MEK: methyl ethyl ketone

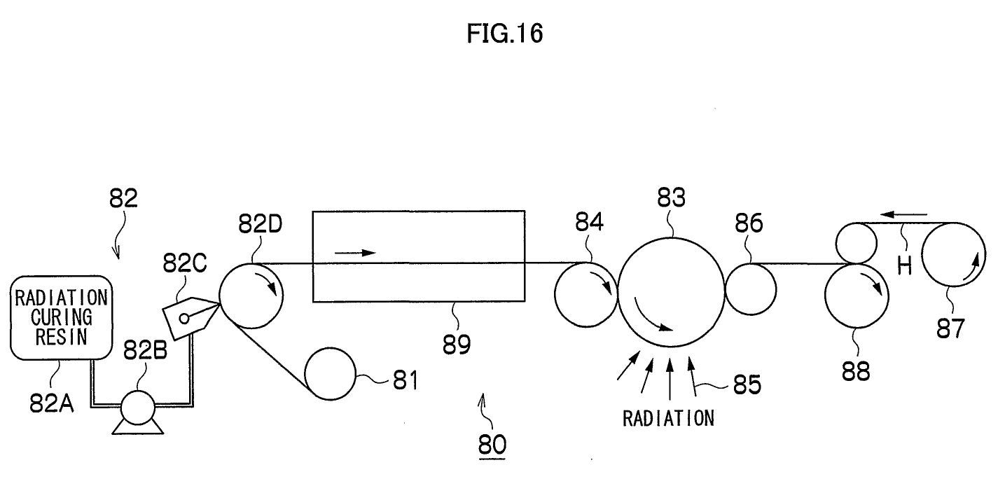

This prism sheet was manufactured using a manufacturing apparatus for a prism sheet of the configuration shown in FIG. 16.

A sheet W was a transparent PET (polyethylene terephthalate) film having a width of 500 mm, a thickness of 100 μm.

An embossing roller 83 was a roller, having a length of 700 mm (in the width direction of the sheet W) and a diameter of 300 mm and a nickel circumferential surface, manufactured by S45C. Grooves having a pitch of 50 μm in the axial direction of the roller were formed in the entire circumferential surface of the roller across approximately 500 mm thereof by a cutting work using diamond bite (single point). The grooves have a triangular cross section having an apex angle of 90° C., and the grooves also have a triangular bottom having an apex angle of 90° C., without any flat portion. That is, the grooves have a width of 50 μm and a depth of about 25 μm. Since the grooves are circumferentially endless, with use of the embossing roller 83, lenticular lenses (prism sheet) having a triangular cross section can be formed in the sheet W. After the grooves were formed, the roller surface was nickel plated.

Coating means 82 was a die coater having an extrusion type of coating head 82C.

A coating solution F (resin solution) was prepared according to the composition shown in FIG. 15. The coating solution F was controlled by a supplying apparatus 82B to be supplied to the coating head 82C so that a film thickness of 20 μm of the wet coating solution F (resin) would be obtained after drying of the organic solvent therein.

Drying means 89 was a drying apparatus of a hot air circulation type. The air was heated to a temperature of 100° C.

A nip roller 84 had a diameter of 200 mm, and was provided with a silicon rubber layer on the circumferential surface thereof, the rubber having a rubber hardness of 90 degrees. The sheet W was pressed between the embossing roller 83 and the nip roller 84 under a nip pressure (effective nip pressure) of 0.5 Pa.

A metal halide lamp was used as resin curing means 85 which irradiated energy of 1000 mJ/cm².

In this way, a prism sheet having a concavo-convex pattern thereon was obtained.

### [Fabrication of First Diffusion Sheet 12]

A first diffusion sheet 12 (a lower diffusion sheet) was fabricated by forming a primer layer, a backcoat layer, and a light diffusing layer in this order as follows.

### Primer Layer

A coating solution A having the following composition was coated to one surface of a polyethylene terephthalate film (substrate) having a thickness 100 μm using a wire bar (wire size=#10), and was dried at 120° C. for two minutes to obtain a primer layer having a thickness of 1.5 μm.

(Coating Solution for Primer Layer)

| | | |
|---|---|---|
| Methanol | 4165 | g |
| JURYMER SP-50T (Nihonjunyaku Co., Ltd.) | 1495 | g |
| Cyclohexanone | 339 | g |
| JURYMER MB-1X (Nihonjunyaku Co., Ltd.) | 1.85 | g |
| (organic particles: crosslinked type polymethyl- | | |
| methacrylate, spherical ultrafine particles | | |
| having weight average particle size 6.2 μm) | | |

### Backcoat Layer

A coating solution B having the following composition was coated to the other surface of the substrate having the primer layer using a wire bar (wire size=#10), and was dried at 120° C. for two minutes to obtain a backcoat layer having a thickness of 2.0 μm.

(Coating Solution for Backcoat Layer)

| | | |
|---|---|---|
| Methanol | 4171 | g |
| JURYMER SP-65T (Nihonjunyaku Co., Ltd.) | 1487 | g |
| Cyclohexanone | 340 | g |
| JURYMER MB-1X (Nihonjunyaku Co., Ltd.) | 2.68 | g |
| (organic particles: crosslinked type polymethyl- | | |
| methacrylate, spherical ultrafine particles | | |
| having weight average particle size 6.2 μm) | | |

### Light Diffusing Layer

A coating solution C having the following composition was coated onto the primer layer on the surface of the substrate having the primer layer and the backcoat layer using a wire bar (wire size=#22), and was dried at 120° C. for two minutes to obtain a light diffusing layer. As will be explained below, the coating solution C was coated in two ways: immediately after the preparation of the coating solution C; and after leaving for 2 hours after the preparation of the coating solution C.

(Coating Solution for Light Diffusing Layer)

| | | |
|---|---|---|
| Cyclohexanone | 20.84 | g |
| Disparon PFA-230, solid content 20% by mass | 0.74 | g |
| (anti-settling agent: fatty acid amide, Kusumoto | | |
| Chemicals, Ltd.) | | |
| Acrylic Resin (DIANAL BR-117, Mitsubishi Rayon Co., | 17.85 | g |
| Ltd.) 20% by mass methyl ethyl ketone solution | | |
| JURYMER MB-20X (Nihonjunyaku Co., Ltd.) | 11.29 | g |
| (organic particles; crosslinked type polymethyl- | | |
| methacrylate, spherical ultrafine particles having | | |
| weight average particle size 18 μm) | | |
| F780F (Dainippon Ink and Chemicals Incorporated) | 0.03 | g |
| (methyl ethyl ketone 30% by mass solution) | | |

### [Fabrication of Second Diffusion Sheet 18]

A second diffusion sheet 18 (an upper diffusion sheet) was fabricated under the same condition and in the same steps described above, except that JURYMER MB-20X of 1.13 g was added to a light diffusing layer instead of that of 11.29 g to the first diffusion sheet 12.

### [Fabrication of Optical Sheet for Display Unit 10:]

### EXAMPLE

Using the above described sheets, an optical sheet for display unit 10 (a module of optical sheet) was fabricated in which, in order from the bottom, a first diffusion sheet 12, a first prism sheet 14, a second prism sheet 16, and a second diffusion sheet 18 were laminated to each other as shown in FIG. 1.

The manufacturing line 11 for optical sheets for display unit (First Manufacturing Method) shown in FIG. 7 was used in this fabrication. A carbon dioxide gas laser irradiation apparatus was used as a laser beam generating apparatus equipped with a laser head 24. The irradiated laser had a wavelength of 10 μm, a power of 25 W, and a frequency of 50 kHz.

The optical sheet for display unit 10 was fabricated by irradiating the laser beam to cut four sides of a stack of the above sheets and also simultaneously bond the four edge portion of the four sides.

### [Fabrication of Optical Sheet for Display Unit:]

### COMPARATIVE EXAMPLE

Using the above described sheets (a first diffusion sheet 12, a first prism sheet 14, a second prism sheet 16, and a second diffusion sheet 18), an optical sheet for display unit was fabricated by individually punching each sheet of a product size, sequentially laminating the sheets one by one, and bonding the sheets to each other.

### [Evaluation of Optical Sheets for Display Unit]

One hundred sets of the optical sheets for display unit fabricated in Example and one hundred sets of the optical sheets for display unit fabricated in Comparative Example were respectively installed in a liquid crystal device, and evaluated with respect to the presence of any damage and failure in those units. When an emission line due to damages was visually observed, the set of the optical sheets with the line was evaluated to be unsatisfactory.

As a result, only one set was evaluated to be unsatisfactory among the one hundred sets of the optical sheets for display unit fabricated in Example, while 24 sets were evaluated to be unsatisfactory among the one hundred sets of the optical sheets for display unit fabricated in Comparative Example. This shows that, with use of the optical sheets for display unit according to Example of the present invention, a significant reduction of damages and failures in optical sheets for display unit can be achieved.

1. A manufacturing method of optical sheet for display unit, comprising:
a laminating step for laminating a diffusion sheet having a flat size of a product size or more to a front surface and/or back surface of at least one lens sheet having a flat size of the product size or more and having convex lenses which are oriented in one axial direction and arranged adjacent to each other generally over an entire surface of the lens sheet;
a cutting step for cutting the stack of the diffusion sheet and the lens sheet along its periphery into the product size; and
a bonding step for bonding the lens sheet and the diffusion sheet to each other at least one or more peripheral points thereof.

2. A manufacturing method of optical sheet for display unit, comprising:
a laminating step for laminating two lens sheets, having a flat size of a product size or more and having convex lenses which are oriented in one axial direction and arranged adjacent to each other generally over an entire surface of each lens sheet, to each other so that the axial directions of the convex lenses on each sheet intersect with each other at a generally right angle, and laminating a diffusion sheet having a flat size of the product size or more to a front surface and/or back surface of the stack of the lens sheets;
a cutting step for cutting the stack of the lens sheets and the diffusion sheet along its periphery into the product size; and
a bonding step for bonding the lens sheets, and the lens sheets and the diffusion sheet to each other at least one or more peripheral points thereof.

3. The manufacturing method of optical sheet for display unit according to claim 1, wherein, in the bonding step, the lens sheet and/or the diffusion sheet are fusion bonded to each other.

4. The manufacturing method of optical sheet for display unit according to claim 1, wherein, in the bonding step, the lens sheet and/or the diffusion sheet are adhesively bonded to each other.

5. The manufacturing method of optical sheet for display unit according to claim 1, wherein the cutting step and the bonding step are performed generally simultaneously by irradiating a laser beam.

6. The manufacturing method of optical sheet for display unit according to claim 1, wherein, in the bonding step, the lens sheet and the diffusion sheet are bonded to each other along at least one peripheral edge portion thereof.

7. The manufacturing method of optical sheet for display unit according to claim 1, wherein, in the bonding step, the lens sheet and the diffusion sheet are bonded to each other along four peripheral edge portions thereof.

8. The manufacturing method of optical sheet for display unit according to claim 2, wherein, in the bonding step, the lens sheets, and the lens sheets and the diffusion sheet are bonded to each other along at least one peripheral edge portion thereof.

9. The manufacturing method of optical sheet for display unit according to claim 2, wherein, in the bonding step, the lens sheets, and the lens sheets and the diffusion sheet are bonded to each other along four peripheral edge portions thereof.

10. The manufacturing method of optical sheet for display unit according to claim 1, wherein the lens sheet and the diffusion sheet have a generally same thermal expansion coefficient.

11. An optical sheet for display unit, comprising:
at least one lens sheet having convex lenses which are oriented in one axial direction and arranged adjacent to each other generally over an entire surface of the lens sheet; and
a diffusion sheet laminated to a front surface and/or back surface of the lens sheet,
wherein the lens sheet and the diffusion sheet are bonded to each other at least one or more peripheral points thereof.

12. An optical sheet for display unit, comprising:
two lens sheets having convex lenses which are oriented in one axial direction and arranged adjacent to each other generally over an entire surface of each lens sheet, the two lens sheets being laminated to each other so that the axial directions of the convex lenses on each sheet intersect with each other at a generally right angle; and
a diffusion sheet laminated to a front surface and/or back surface of the stack of the lens sheets,
wherein the two lens sheets, and the lens sheets and the diffusion sheet are bonded to each other at least one or more peripheral points thereof.

13. A manufacturing method of optical sheet for display unit, comprising:
a laminating step for laminating two or more optical sheets having a flat size of a product size or more to each other;
a cutting step for cutting the stack of the optical sheets along its periphery into the product size; and
a bonding step for bonding the stack of the optical sheets together at least one or more peripheral points thereof.

14. A manufacturing method of optical sheet for display unit, comprising:
a laminating step for laminating an optical sheet having a flat size of a product size or more to a front surface and/or back surface of at least one lens sheet having a flat size of the product size or more and having convex lenses which are oriented in one axial direction and arranged adjacent to each other generally over an entire surface of the lens sheet;
a cutting step for cutting the stack of the optical sheet and the lens sheet along its periphery into the product size; and
a bonding step for bonding the optical sheet and the lens sheet to each other at least one or more peripheral points thereof.

15. A manufacturing method of optical sheet for display unit, comprising:
a laminating step for laminating two lens sheets, having a flat size of a product size or more and having convex lenses which are oriented in one axial direction and arranged adjacent to each other generally over an entire surface of the lens sheet, to each other so that the axial directions of the convex lenses on each sheet intersect with each other at a generally right angle, and laminating an optical sheet having a flat size of the product size or more to a front surface and/or back surface of the stack of the lens sheets;
a cutting step for cutting the stack of the optical sheet and the lens sheets along its periphery into the product size; and
a bonding step for bonding the two lens sheets, and the lens sheets and the optical sheet to each other at least one or more peripheral points thereof.

16. The manufacturing method of optical sheet for display unit according to claim 13, wherein, in the bonding step, the lens sheet and/or the optical sheet are fusion bonded to each other.

17. The manufacturing method of optical sheet for display unit according to claim 13, wherein, in the bonding step, the lens sheet and/or the optical sheet are adhesively bonded to each other.

18. The manufacturing method of optical sheet for display unit according to claim 13, wherein the cutting step and the bonding step are performed generally simultaneously by irradiating a laser beam.

19. The manufacturing method of optical sheet for display unit according to claim 13, wherein, in the bonding step, the optical sheets are bonded to each other along at least one peripheral edge portion thereof.

20. The manufacturing method of optical sheet for display unit according to claim 13, wherein, in the bonding step, the optical sheets are bonded to each other along four peripheral edge portions thereof.

21. The manufacturing method of optical sheet for display unit according to claim 14, wherein, in the bonding step, the lens sheet and the optical sheet are bonded to each other along at least one peripheral edge portion thereof.

22. The manufacturing method of optical sheet for display unit according to claim 14, wherein, in the bonding step, the lens sheet and the optical sheet are bonded to each other along four peripheral edge portions thereof.

23. The manufacturing method of optical sheet for display unit according to claim 15, wherein, in the bonding step, the lens sheets, and the lens sheets and the optical sheet are bonded to each other along at least one peripheral edge portion thereof.

24. The manufacturing method of optical sheet for display unit according to claim 15, wherein, in the bonding step, the lens sheets, and the lens sheets and the optical sheet are bonded to each other along four peripheral edge portions thereof.

25. The manufacturing method of optical sheet for display unit according to claim 13, wherein the lens sheet and the optical sheet have a generally same thermal expansion coefficient.

26. An optical sheet for display unit, comprising:
two or more optical sheets which are laminated and bonded to each other at least one or more peripheral points thereof.

27. An optical sheet for display unit, comprising:
at least one lens sheet having convex lenses which are oriented in one axial direction and arranged adjacent to each other generally over an entire surface of the lens sheet; and
an optical sheet laminated to a front surface and/or back surface of the lens sheet,
wherein the lens sheet and the optical sheet are bonded to each other at least one or more peripheral points thereof.

28. An optical sheet for display unit, comprising:
two lens sheets having convex lenses which are oriented in one axial direction and arranged adjacent to each other generally over an entire surface thereof, the two lens sheets being laminated to each other so that the axial directions of the convex lenses on each sheet intersect with each other at a generally right angle; and
an optical sheet laminated to a front surface and/or back surface of the stack of the lens sheets,
wherein the two lens sheets, and the lens sheets and the optical sheet are bonded to each other at least one or more peripheral points thereof.

29. A manufacturing method of optical sheet for display unit, comprising:
a laminating step for laminating an optical sheet having a flat size of a product size or more to a front surface and/or back surface of at least one lens sheet having a flat size of the product size or more and having convex lenses which have a generally similar shape and are arranged adjacent to each other in a matrix generally over an entire surface of the lens sheet;
a cutting step for cutting the stack of the optical sheet and the lens sheet along its periphery into the product size; and
a bonding step for bonding the optical sheet and the lens sheet to each other at least one or more peripheral points thereof.

30. The manufacturing method of optical sheet for display unit according to claim 29, wherein the convex lenses have a conical shape.

31. The manufacturing method of optical sheet for display unit according to claim 29, wherein the optical sheet is a diffusion sheet.

32. The manufacturing method of optical sheet for display unit according to claim 29, wherein, in the bonding step, the lens sheet and/or the optical sheet are fusion bonded to each other.

33. The manufacturing method of optical sheet for display unit according to claim 29, wherein, in the bonding step, the lens sheet and/or the optical sheet are adhesively bonded to each other.

34. The manufacturing method of optical sheet for display unit according to claim 29, wherein the cutting step and the bonding step are performed generally simultaneously by irradiating a laser beam.

35. The manufacturing method of optical sheet for display unit according to claim 29, wherein in the bonding step, the lens sheet and the optical sheet are bonded to each other along at least one peripheral edge portion thereof.

36. The manufacturing method of optical sheet for display unit according to claim 29, wherein in the bonding step, the lens sheet and the optical sheet are bonded to each other along at four peripheral edge portions thereof.

37. The manufacturing method of optical sheet for display unit according to claim 29, wherein the lens sheet and the optical sheet have a generally same thermal expansion coefficient.

38. An optical sheet for display unit, comprising:
at least one lens sheet having a flat size of a product size or more and having convex lenses which have a generally similar shape and are arranged adjacent to each other in a matrix generally over an entire surface of the lens sheet; and
an optical sheet which has a flat size of the product size or more and is laminated to a front surface and/or back surface of the at least one lens sheet,
wherein the lens sheet and the optical sheet are bonded to each other at least one or more peripheral points thereof.

39. The optical sheet for display unit according to claim 38, wherein the convex lens has a conical shape.

40. The optical sheet for display unit according to claim 38, wherein the optical sheet is a diffusion sheet.
